(19) United States
(12) Patent Application Publication
(10) Pub. No.: US 2026/0192555 A1
(43) Pub. Date: Jul. 9, 2026

(54) COMPOSITES

(71) Applicant: BIOME BIOPLASTICS LIMITED, Southampton (GB)

(72) Inventors: Daniel ARNILLAS, Southampton (GB); Gaelle CAVALIE, Southampton (GB); Paul MINES, Southampton (GB); John RYAN, Southampton (GB)

(21) Appl. No.: 19/177,377

(22) Filed: Apr. 11, 2025

Related U.S. Application Data
(63) Continuation of application No. PCT/EP2024/069093, filed on Jul. 5, 2024.

(30) Foreign Application Priority Data
Sep. 8, 2023 (EP) 23196390.1

(51) Int. Cl. B32B 27/36; B32B 27/08; B32B 37/15

(52) U.S. Cl. CPC B32B 27/36; B32B 27/08; B32B 37/153; B32B 2250/02; B32B 2307/54; B32B 2307/7163; B32B 2553/00

(57) ABSTRACT

The present application relates to a substantially planar composite suitable for use in a form fill sealing package. The substantially planar composite comprises an upper outer surface component comprising a biodegradable and/or compostable polymeric material; and a lower outer surface component comprising a biodegradable and/or compostable polymeric material having a softening point at least around 15° C. lower than the softening point of the biodegradable and/or compostable polymeric material of the upper outer surface component.

### TECHNICAL FIELD

The present disclosure relates to substantially planar composites suitable for use in a form fill sealing package, and methods of forming/using said composites.

### BACKGROUND

Form fill sealing (e.g. vertical form fill sealing, VFFS, or horizontal form fill sealing, HFFS) is a useful method of packaging, employed in the industrial packaging of various products. Many packaging materials for use in these techniques cause an environmental impact because they comprise plastics which are produced from fossil fuels and/or comprise mixtures of different polymers and/or otherwise have typically poor, if any, biodegradability/compostability.

However, it is often the case that biodegradable and/or compostable packaging materials suffer from reduced performance compared to their non-biodegradable/compostable analogues.

It would be desirable to provide a packaging material and/or product which are suitable for use in a form fill sealing package and are also biodegradable and/or compostable. It would also be desirable to obviate, mitigate and/or ameliorate one or more deficiencies in known packaging materials and/or products, whether identified herein or otherwise, or to provide an alternative.

### SUMMARY

According to a first aspect of the present disclosure, there is provided a substantially planar composite suitable for use in a form fill sealing package, the substantially planar composite comprising:
an upper outer surface component comprising a biodegradable and/or compostable polymeric material; and
a lower outer surface component comprising a biodegradable and/or compostable polymeric material having a softening point at least around 15° C. lower than the softening point of the biodegradable and/or compostable polymeric material of the upper outer surface component.

According to a second aspect of the present disclosure, there is provided a form fill seal packaging material comprising a substantially planar composite, the substantially planar composite comprising:
an upper outer surface component comprising a biodegradable and/or compostable polymeric material; and
a lower outer surface component comprising a biodegradable and/or compostable polymeric material having a softening point at least around 15° C. lower than the softening point of the biodegradable and/or compostable polymeric material of the upper outer surface component.

According to a third aspect of the present disclosure, there is provided a method of joining one or more substantially planar composites as defined in relation to the first aspect in the paragraphs above or one or more form fill seal packaging materials as defined in relation to the second aspect in the paragraphs above (e.g. joining to form a package), the method comprising:
heating two portions of the biodegradable and/or compostable polymeric material of the lower outer surface component above the softening point of the biodegradable and/or compostable polymeric material of the lower outer surface and preferably below the softening point of the biodegradable and/or compostable polymeric material of the upper outer surface component; and
bringing said portions into contact with one another.

According to a fourth aspect of the present disclosure, there is provided a method of forming a substantially planar composite as defined in relation to the first aspect in the paragraphs above or a form fill seal packaging material as defined in relation to the second aspect in the paragraphs above, wherein the method comprises:
extruding the biodegradable and/or compostable polymeric material of the upper outer surface component to form the upper outer surface component;
extruding the biodegradable and/or compostable polymeric material of the lower outer surface component to form the lower outer surface component; and
connecting (e.g. by co-extruding) the upper and lower outer surface components to form the substantially planar composite.

According to a fifth aspect of the present disclosure, there is provided a method of forming a substantially planar composite as defined in relation to the first aspect in the paragraphs above or a form fill seal packaging material as defined in relation to the second aspect in the paragraphs above, the method comprising:
providing a layer of the biodegradable and/or compostable polymeric material of the upper outer surface component;
providing a layer of the biodegradable and/or compostable polymeric material of the outer surface component; and
laminating the layers together.

### Definitions

The following definitions apply for terms used herein. In the event that any term is not specifically defined here or otherwise, the standard meaning in the present technical field prevails. This standard meaning may bear in mind definitions provided in common general knowledge (e.g. standard textbooks) in the present technical field. Usefully, for example, chemical terms may be interpreted in accordance with the Compendium of Chemical Terminology (2019), version 3.0.1, informally known as the “Gold Book”.

The term “at least one” is synonymous with “one or more”, e.g. one, two, three, four, five, six, or more.

Where the term “at least” is applied to ratios, this should be interpreted as referring to the fact that the first number in the ratio is the number shown or is larger than the number shown, and/or the second number in the ratio is the number shown or is correspondingly smaller than the number shown. For example, a substantially planar composite described as having a thickness ratio of “at least around 25:75 upper outer surface component to lower outer surface component” means that a ratio described as such may have values such as 25:75, or 30:75, or 25:70.

The converse of the above is true when the term “at most” is applied to ratios.

As used herein, the terms “around”, “about” or “substantially” generally encompass or refer to a range of values that one skilled in the art would consider equivalent to the recited values (e.g. having the same function or result, and/or achieved substantially in the same way). Suitably, where the term “about” is used in relation to a numerical value, it can represent (in increasing order of preference) a 10%, 5%, 2%, 1% or 0% deviation from that value.

The term “composite”, as used herein, refers to an item made up of two or more joined components. Said components may be discrete, or there may be an interface between different components, wherein said interface comprises the different components.

The terms “planar” and/or “substantially planar”, as used herein, mean generally flat. A planar/substantially planar object can also be flexible, bendable and/or foldable, such that it can be converted from a completely flat object-such flexed, bent and/or folded objects are also intended to be embraced by the terms “planar” and/or “substantially planar” since, although the 3D structure is non-planar, it is nonetheless made up of a substantially planar object (e.g. the object provides a planar net and folding this net yields the 3D structure, made up of the planar net). Examples of planar/substantially planar objects are sheets and films.

The term “outer surface component”, as used herein in the context of a substantially planar composite, refers to a component which forms an outer surface of the composite. For example, the “upper outer surface component” may be a sheet, forming an upper part of the composite, and the “lower outer surface component” may be another sheet and the two sheets may be joined together, the lower outer surface component forming a lower part of the composite.

An outer surface component may also be an extrudate, e.g. an upper outer extruded component or a lower outer extruded component.

An outer surface component may be a discrete component of a composite (i.e. a self-contained component with a defined boundary between itself and other component(s)), such as a film or sheet. In this case, the outer surface component may be or have been laminated onto the other component(s) (e.g. the upper/lower outer surface component, the core material, etc.) or vice versa. Laminating may comprise bonding the components with adhesive, for instance.

Alternatively, outer surface components may each be non-discrete components of a composite, e.g. the components may be integral with one another. In such instances, there may be an interface between the outer surface component and another component of the composite, wherein said interface comprises both the outer surface component (or a sub-component thereof) and the other component (or a sub-component thereof). For example, the upper and lower outer surface components may be co-extruded, yielding an integral bicomponent structure having an interface between the two components. At the interface, it will be understood that there is a mixture of the components arising from the mutual diffusion/movement of polymers from each component.

The terms “upper” and “lower” are relative labels used to denote/distinguish consistently between different outer surface components. As used herein, they label one component (lower outer surface component comprising a polymeric material) having a lower softening point than that of the other component (upper outer surface component polymeric material). It will be appreciated that the opposite configuration is also encompassed (wherein the lower outer surface component comprising a polymeric material has a higher softening point than that of the polymeric material of the upper outer surface component).

Where the “thickness” of an object (e.g. a substantially planar composite or component thereof) is recited, this can be understood to refer to the spatial dimension extending transverse to the plane of the object (i.e. the smallest spatial dimension of a planar sheet). For example, an object may have the dimensions 10 cm (width) by 10 cm (length) by 1 mm (thickness). Where the thickness is expressed as a thickness ratio, such as at least around 25:75 upper outer surface component to lower outer surface component, this means that the upper outer surface component has a thickness which is three times bigger than the lower outer surface component (i.e. 75 is three times bigger than 25). The thicknesses could be, for example, 25 mm upper outer surface component and 75 mm lower outer surface component; or, for example, 10 mm upper outer surface component and 30 mm lower outer surface component.

The term “biodegradable”, as used herein, means degradable by means of microorganisms, such as fungi, bacteria, viruses, algae, etc., and/or by exposure to enzymatic mechanisms. As applied to a given material, such as an upper outer surface component comprising a biodegradable and/or compostable polymeric material, the requirement “biodegradable” should be understood to be met if the majority of that polymeric material is biodegradable, i.e. if it is “partially” biodegradable. Suitably, at least about 60% of the material may be biodegradable, on a weight basis; optionally at least about 70%; optionally at least about 80%; optionally at least about 90%; optionally at least about 95%; optionally about 100% of the product may be biodegradable. Generally speaking, greater biodegradability is preferred.

The term “compostable” (e.g. home compostable), as used herein, means degradable to form compost. As applied to a given material, such as an upper outer surface component comprising a biodegradable and/or compostable polymeric material, the requirement “compostable” should be understood to be met if the majority of that polymeric material is compostable, i.e. if it is “partially” compostable. Suitably, at least about 60% of the material may be compostable, on a weight basis; optionally at least about 70%; optionally at least about 80%; optionally at least about 90%; optionally at least about 95%; optionally about 100% of the product may be compostable. Generally speaking, greater compostability is preferred. A compostable material may be able to pass the threshold assessments set out in EN13432 (2015) and/or ASTM D6400-21.

When the term “home compostable” is used herein to describe a material, this may be understood to mean the material is able to pass the threshold assessment set out in AS 5810-2010 (Australian Standard: Biodegradable plastics-Biodegradable plastics suitable for home composting). Specifically, the material passes the four procedures of the assessment: characterisation, biodegradability, disintegration and compost quality (including toxicity). In the biodegradability procedure, the test method used is that given in ISO 14855-1:2012 (E) (Determination of the ultimate aerobic biodegradability of plastic materials under controlled composting conditions—Method by analysis of evolved carbon dioxide—Part 1: General method), wherein the ambient temperature is fixed at 28° C.

When the term “soil biodegradable” is used herein to describe a material, this may be understood to mean the material is able to pass the threshold assessment set out in ISO 17556:2019 (E) (Plastics—Determination of the ultimate aerobic biodegradability of plastic materials in soil by measuring the oxygen demand in a respirometer or the amount of carbon dioxide evolved). This assessment involves preparing a test soil, and monitoring the degradation of the test material compared to a reference material at a fixed temperature of around 20 to 28° C.

The term “high-softening-point polymer”, as used herein, refers to a polymer that increases the softening point of a substance (e.g. a polymeric blend) of which said high-softening-point polymer is a part.

The term “plasticising polymer”, as used herein, refers to a polymer that improves processability (e.g. form fill sealing processability, extrudability, and the like) and/or thermomechanical properties.

The term “heat sealable” is well-known in the art. For the avoidance of any doubt, polymeric materials that are brought into contact with one another are heat sealable will form a seal on the application of heat, e.g. by heating the materials above a softening point to enable co-mingling of polymers at the point of contact.

The softening point of a polymer, polymeric blend or other polymeric material may be determined with reference to the minimum temperature at which the polymer, polymeric blend or other polymeric material deforms under a particular load. The softening point may refer to the heat deflection temperature (HDT), which may be determined using the method set out in ISO 75-1:2020 (specifically the B-50 method). A Ray-Ran RR/HDVR HDT/vicat testing machine may be used. For the measurement of HDT values quoted herein, the applied stress used for testing was 0.45 Mpa, and the temperature was increased at a ramp rate of 50° C.·h⁻¹.

Alternatively, the softening point may refer to the Vicat softening temperature, which may be determined using the method set out in ISO 306:2022 (specifically the A120 method) or ASTM D1525. A Ray-Ran RR/HDVR HDT/vicat testing machine may be used.

The term “onset melting point” refers to the minimum temperature at which a substance begins to melt. The onset melting point may be measured by differential scanning calorimetry (DSC), where the onset melting point corresponds to the temperature at which the melting point peak begins.

The term “melting point” refers to the minimum temperature at which the majority of a substance is melting. The melting point may be measured by DSC, where the melting point corresponds to the temperature at which the melting point peak reaches a maximum.

DSC may suitably be used to determine the glass transition temperature (T_{g}) and the melting point of polymers, polymeric blends and other polymeric materials. The glass transition temperature of the material may be measured using ASTM D3418-15 and/or ISO 11357-2:2013.

FIGS. 4 to 7 show exemplary DSC curves for various components/polymers, with the onset melting point, melting point and glass transition temperature (T_{g}) labelled, for reference.

Crystallinity can also be established by DSC, using the method set out in ISO 11357-1:2023 for example. The DSC spectra for a semi-crystalline material (i.e. a material that is not completely crystalline) that has low crystallinity will typically have three main types of thermal transition. These are (i) a step change in the energy flow at the glass transition temperature (T_{g}) of the material, which can be due to a change in the heat capacity of the material; (ii) an exothermic region at the crystallisation temperature (T_{c}) of the material; and (iii) an endothermic region at the melting point (Tₘ) of the polymer.

Conversely, increased crystallinity can result in a reduction or removal of the exothermic crystallisation peak in the DSC spectra, depending on the extent of increase in crystallinity. A decrease in the magnitude of the exothermic crystallisation peak is therefore an indication of the extent of increase in material crystallinity (i.e. of the low crystallinity material as compared to the higher crystallinity material).

When used herein, the Young's modulus, tensile strength and strain of materials may be measured using the assessment set out in ISO 527-1:2019.

When used herein, the dart drop impact strength of materials may be measured using the assessment set out in ASTM D1709-22 (Test Method A).

When used herein, the puncture resistance of materials may be measured using the assessment set out in EN14477 (2004).

The term “monomer” is one of the art. For the avoidance of any doubt, monomers are molecules that can be bonded to other molecules to form a polymer or a copolymer comprising units of the monomer.

The term “polymer” as used herein may refer to a molecule comprising two or more (such as three or more, four or more, five or more, six or more, seven or more, eight or more, nine or more, or ten or more) monomer units. A polymer may comprise many monomer units, such as 100 or more or 1000 or more monomer units.

The term “polymeric blend”, as used herein, refers to a mixture/blend of two or more different polymers. The two or more polymers in the blend typically do not react with one another during said mixture/blending and are thereby present as two or more distinct chemical entities.

The term “poly(lactic acid)”, abbreviated as “PLA”, refers to a specific polymer having the chemical structure:

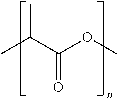

wherein “n” is an integer of two or more (such as three or more, four or more, five or more, six or more, seven or more, eight or more, nine or more, or ten or more), representing the number of monomer units in the polymer. PLA may comprise many monomer units, such as 100 or more monomer units. A typical molecular weight for PLA may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “poly(butylene succinate)”, abbreviated as “PBS”, refers to a specific polymer having the chemical structure:

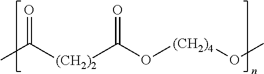

wherein “n” is an integer of two or more (such as three or more, four or more, five or more, six or more, seven or more, eight or more, nine or more, or ten or more), representing the number of monomer units in the polymer. PBS may comprise many monomer units, such as 100 or more monomer units. A typical molecular weight for PBS may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “poly(butylene succinate co-adipate)”, abbreviated as “PBSA”, refers to a specific polymer having the chemical structure:

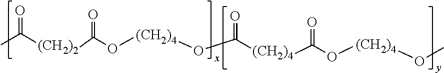

wherein “x” and “y” are integers of one or more, representing the number of each monomer unit in the polymer. A typical x:y ratio for PBSA is around 5:1 to 1:5, optionally around 4:1 to 1:4, optionally around 3:1. The polymer may comprise either a random sequence of the two monomers shown, and/or alternating blocks of like monomers. A typical molecular weight for PBSA may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “poly(caprolactone)”, abbreviated as “PCL”, refers to a specific polymer having the chemical structure:

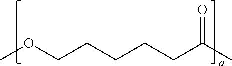

wherein “a” is an integer of two or more (such as three or more, four or more, five or more, six or more, seven or more, eight or more, nine or more, or ten or more), representing the number of monomer units in the polymer. PCL may comprise many monomer units, such as 100 or more monomer units. A typical molecular weight for PCL may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa, optionally around 40 to 90 kDa.

The term “poly(butylene adipate-co-terephthalate)”, abbreviated as “PBAT”, refers to a specific polymer having the chemical structure:

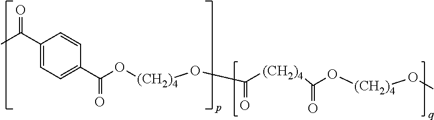

wherein “p” and “q” are integers of one or more, representing the number of each monomer unit in the polymer. A typical p:q ratio for PBAT is around 5:1 to 1:5, optionally around 4:1 to 1:4, optionally around 3:1 to 1:3, optionally around 2:1 to 1:2, optionally around 0.55:0.45. The polymer may comprise either a random sequence of the two monomers shown, and/or alternating blocks of like monomers. A typical molecular weight for PBAT is around may be:
(a) at least around 1 kDa, optionally at least around 10 kDa, optionally at least around 20 kDa, optionally at least around 30 kDa, optionally at least around 40 kDa, optionally at least around 50 kDa, optionally at least around 60 kDa; and/or
(b) at most around 1000 kDa, optionally at most around 500 kDa, optionally at most around 400 kDa, optionally at most around 300 kDa, optionally at most around 200 kDa, optionally at most around 100 kDa, optionally at most around 65 kDa; and/or
(c) around 1 to 1000 kDa, optionally around 10 to 500 kDa, optionally around 20 to 400 kDa, optionally around 30 to 300 kDa, optionally around 40 to 200 kDa, optionally around 50 to 100 kDa, optionally around 60 to 65 kDa.

The term “poly(butylene succinate-co-terephthalate)”, abbreviated as “PBST”, refers to a specific polymer having the chemical structure:

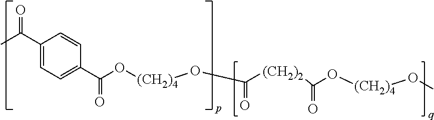

wherein “p” and “q” are integers of one or more, representing the number of each monomer unit in the polymer. A typical p:q ratio for PBST is around 5:1 to 1:5, optionally around 4:1 to 1:4, optionally around 3:1 to 1:3, optionally around 2:1 to 1:2, optionally around 0.55:0.45. Commercially available p:q ratios are typically around 3:1 to 4:1. The polymer may comprise either a random sequence of the two monomers shown, and/or alternating blocks of like monomers. A typical molecular weight for PBST may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “poly(butylene sebacate-co-terephthalate)”, abbreviated as “PBSeT”, refers to a specific polymer having the chemical structure:

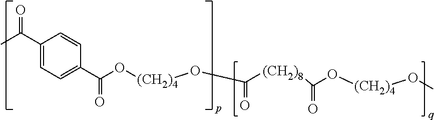

wherein “p” and “q” are integers of one or more, representing the number of each monomer unit in the polymer. A typical p:q ratio for PBSeT is around 5:1 to 1:5, optionally around 4:1 to 1:4, optionally around 3:1 to 1:3, optionally around 2:1 to 1:2, optionally around 0.55:0.45. The polymer may comprise either a random sequence of the two monomers shown, and/or alternating blocks of like monomers. A typical molecular weight for PBSeT may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “poly(hydroxyalkanoate)”, abbreviated as “PHA”, refers to a class of polymers comprising monomers of formula:

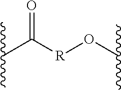

wherein R is an alkylene group. A PHA may comprise monomers which are all the same, or which differ in the identity of R. A typical molecular weight for PHA may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “poly(butyrate)”, abbreviated as “PHB”, refers to a class of polymers comprising monomers of formula:

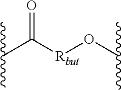

wherein R_{but} is a C₃ alkylene group. A PHB may comprise monomers which are all the same, or which differ in the identity of R_{but}. A typical molecular weight for PHB and the butyrate-containing copolymers below (PHBV, PHBH, PHBO, PHBD, PBAF, PBAP, PBAP) may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “poly(3-hydroxybutyrate-co-3-hydroxyvalerate)”, abbreviated as “PHBV”, refers to a specific polymer comprising monomers of formulae:

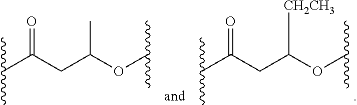

The term “poly(3-hydroxybutyrate-co-3-hydroxyhexanoate)”, abbreviated as “PHBH”, refers to a specific polymer comprising monomers of formulae:

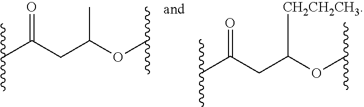

The term “poly(3-hydroxybutyrate-co-3-hydroxyoctanoate)”, abbreviated as “PHBO”, refers to a specific polymer comprising monomers of formulae:

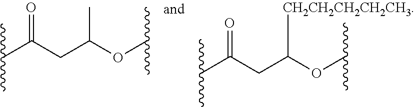

The term “poly(3-hydroxybutyrate-co-3-hydroxydecanoate)”, abbreviated as “PHBD”, refers to a specific polymer comprising monomers of formulae:

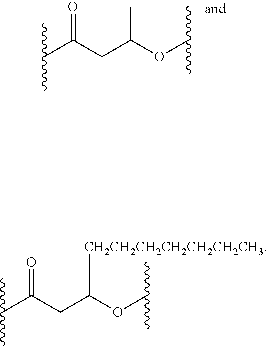

The term “poly(3-hydroxyvalerate-co-3-hydroxyhexanoate)”, abbreviated as “PHVH”, refers to a specific polymer comprising monomers of formulae:

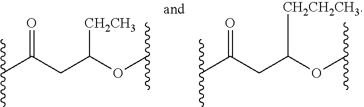

A typical molecular weight for PHVH may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “poly(glycolic acid)”, abbreviated as “PGA”, refers to a specific polymer having the chemical structure:

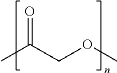

wherein “n” is an integer of two or more (such as three or more, four or more, five or more, six or more, seven or more, eight or more, nine or more, or ten or more, etc.), representing the number of monomer units in the polymer. A typical molecular weight for PGA may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “2,5-poly(butyrate adipate furandicarboxylate)”, abbreviated as “2,5-PBAF”, refers to a specific polymer having the structure:

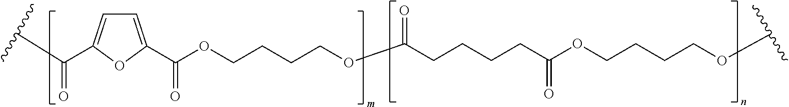

wherein “m” and “n” are integers of one or more, representing the number of each monomer unit in the polymer. A typical min ratio for 2,5-PBAF is around 5:1 to 1:5, optionally around 4:1 to 1:4, optionally around 3:1 to 1:3, optionally around 2:1 to 1:2, optionally around 0.55:0.45. The polymer may comprise either a random sequence of the two monomers shown, and/or alternating blocks of like monomers.

The term “2,4-poly(butyrate adipate pyridinedicarboxylate)”, abbreviated as “2,4-PBAP”, refers to a specific polymer having the structure:

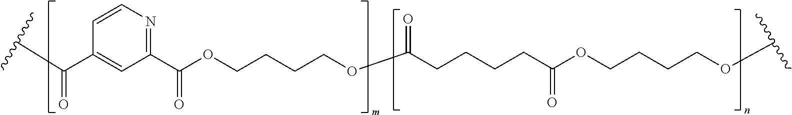

wherein “m” and “n” are integers of one or more, representing the number of each monomer unit in the polymer. A typical min ratio for 2,4-PBAP is around 5:1 to 1:5, optionally around 4:1 to 1:4, optionally around 3:1 to 1:3, optionally around 2:1 to 1:2, optionally around 0.55:0.45. The polymer may comprise either a random sequence of the two monomers shown, and/or alternating blocks of like monomers.

The term “2,5-poly(butyrate adipate pyridinedicarboxylate)”, abbreviated as “2,5-PBAP”, refers to a specific polymer having the structure:

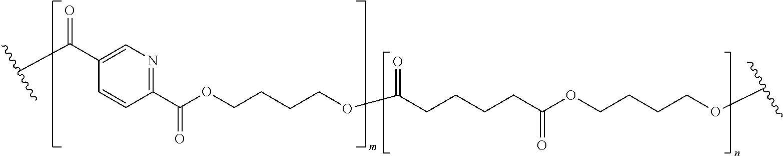

wherein “m” and “n” are integers of one or more, representing the number of each monomer unit in the polymer. A typical min ratio for 2,5-PBAP is around 5:1 to 1:5, optionally around 4:1 to 1:4, optionally around 3:1 to 1:3, optionally around 2:1 to 1:2, optionally around 0.55:0.45. The polymer may comprise either a random sequence of the two monomers shown, and/or alternating blocks of like monomers.

The term “poly(vinyl alcohol)”, abbreviated as “PVOH”, refers to a specific polymer having the chemical structure:

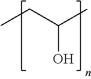

wherein “n” is an integer of two or more (such as three or more, four or more, five or more, six or more, seven or more, eight or more, nine or more, or ten or more), representing the number of monomer units in the polymer. A typical molecular weight for PVOH may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “cellulose” refers to a specific polymer comprising monomers of formula:

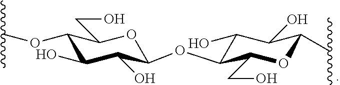

A typical molecular weight for cellulose (and cellulose derivatives below) may be:
(a) at least around 1 kDa, optionally at least around 10 kDa, optionally at least around 20 kDa, optionally at least around 30 kDa, optionally at least around 40 kDa; and/or
(b) at most around 1000 kDa, optionally at most around 500 kDa, optionally at most around 400 kDa, optionally at most around 300 kDa, optionally at most around 200 kDa; and/or
(c) around 1 to 1000 kDa, optionally around 10 to 500 kDa, optionally around 20 to 400 kDa, optionally around 30 to 300 kDa, optionally around 40 to 200 kDa.

The term “cellulose derivative” refers to a class of polymers comprising monomer of formula:

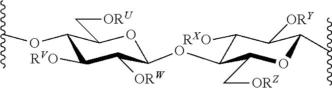

wherein R^{U}, R^{V}, R^{W}, R^{X}, R^{Y}, R^{Z} are each independently H or a substituting group (e.g. an alkyl or acyl group, e.g. C(O)CH₃, C(O)CH₂CH₃, C(O)CH₂CH₂CH₃ or C(O)CH(CH₃)₂) provided that at least one of R^{U}, R^{V}, R^{W}, R^{X}, R^{Y}, R^{Z} is a substituting group.

The term “cellulose acetate” refers to a specific polymer comprising monomers of formula:

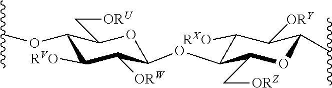

wherein R^{U}, R^{V}, R^{W}, R^{X}, R^{Y}, R^{Z} are each independently H or C(O)CH₃, provided that at least one of R^{U}, R^{V}, R^{W}, R^{X}, R^{Y}, R^{Z} is C(O)CH₃.

The term “cellulose propionate” refers to a specific polymer comprising monomers of formula:

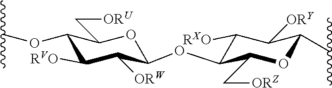

wherein R^{U}, R^{V}, R^{W}, R^{X}, R^{Y}, R^{Z} are each independently H or C(O)CH₂CH₃, provided that at least one of R^{U}, R^{V}, R^{W}, R^{X}, R^{Y}, R^{Z} is C(O)CH₂CH₃.

The term “cellulose butyrate” refers to a specific polymer comprising monomers of formula:

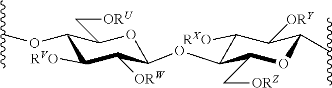

wherein R^{U}, R^{V}, R^{W}, R^{X}, R^{Y}, R^{Z} are each independently H, C(O)CH₂CH₂CH₃ or C(O)CH(CH₃)₂, provided that at least one of R^{U}, R^{V}, R^{W}, R^{X}, R^{Y}, R^{Z} is C(O)CH₂CH₂CH₃ or C(O)CH(CH₃) 2.

It can be assumed that the ends of polymers and/or co-polymers referred to herein have filled valences, e.g. through bonding to atoms (such as hydrogen) or groups of atoms (e.g. end groups such as unreacted hydroxyl groups, capping groups or protecting groups).

### BRIEF DESCRIPTION OF THE FIGURES

The disclosure will now be described with reference to the following Figures:

FIG. 1 Photograph of a substantially planar composite on which heat sealing has been attempted at two different temperatures.

FIG. 2 Photograph of a substantially planar composite on which heat sealing has been attempted at three different temperatures.

FIG. 3 Schematic diagram of an exemplary substantially planar composite.

FIG. 4 DSC trace for a lower outer surface component comprising PBSA.

FIG. 5 DSC trace for a core comprising PBAT and native starch.

FIG. 6 DSC trace for an upper outer surface component comprising PHBH, PBAT and native starch.

FIG. 7 DSC trace for PLA.

### DETAILED DESCRIPTION

According to a first aspect of the present disclosure, there is provided a substantially planar composite suitable for use in a form fill sealing package, the substantially planar composite comprising:
an upper outer surface component comprising a biodegradable and/or compostable polymeric material; and
a lower outer surface component comprising a biodegradable and/or compostable polymeric material having a softening point at least around 15° C. lower than the softening point of the biodegradable and/or compostable polymeric material of the upper outer surface component.

Form fill sealing is a packaging process commonly used in food packaging. In the process, a flat roll of film traverses a form fill sealing machine (such as a vertical form fill sealing, VFFS, machine) and is formed into a tubular cylinder. Along the length of the tube, edges of the film (which are brought together to form the tube) are sealed together (e.g. by heat sealing as discussed herein). The inside of the tubular cylinder is dosed with product for packaging (e.g. food, crisps, etc). Finally, open ends of the tube are sealed (e.g. heat sealed) to close the package. It will be appreciated that these steps can be conducted in different sequences, depending on the configuration of the processing machinery.

It has been surprisingly found that biodegradable and/or compostable polymeric materials can be used in form fill sealing packages by use of a substantially planar composite having at least the upper and lower surface components, with specific materials having the recited difference in softening points. When such composites are sealed (e.g. by heating at a temperature above the softening point of the lower outer surface component), it has been found that the lower outer surface component is able to form a seal (e.g. joining two parts thereof together, e.g. in the formation of a tubular cylinder as described above) whilst the upper outer surface component is able to remain undistorted (e.g. because heating is below a softening temperature of the upper outer surface component). The upper outer surface component may form the outer part of a package and it will be appreciated that avoiding distortion (e.g. by softening) is desirable to maintain the integrity and/or appearance of the outer part Additionally, if said outer component is heated above its softening point, parts of the component can stick to the heating elements or other machinery parts (e.g. rollers), further detracting from structural integrity and/or appearance.

During heat sealing, heat is usually applied directly (using a heating element) in a region adjacent the upper outer surface component—it will be appreciated that this arrangement is typically needed in the context of tubular cylindrical processing as described above, since heating elements are typically located outside of the cylinder (i.e. adjacent the upper outer surface component). Application of heat to the upper outer surface component is not particularly desirable, but is needed to also transmit heat to the inner outer surface component (through the upper outer surface component) and thereby to enable softening and sealing of the inner outer surface component. It has been surprisingly found that certain biodegradable and/or compostable polymeric materials have softening temperatures suitable for use in the upper and lower components which allow softening of the inner component without distortion of the outer component.

It will be appreciated that selection of polymers/blends which have the requisite softening/onset melting/heat sealing temperatures for these multi-component composites can greatly simplify manufacturing techniques. For example, the components in these composites can be co-extruded, offering a simplified construction as compared with laminated composites (e.g. where films, e.g. cellulosic films, are bonded together using adhesives).

Heat sealing is a general term to describe the formation of a bond, e.g. a bond between the upper and lower outer surface components (and/or the core material, if present). Without wishing to be bound by theory, it is believed that this strong adhesion results from entanglement and/or non-covalent bonding (e.g. hydrogen bonding) between the biodegradable and/or compostable materials of the upper and lower surface components (e.g. at an interface thereof). Bonding/sealing occurs over a range of temperatures and is generally understood to substantially begin around the softening point of a material-here, the polymeric materials become more mobile and thereby able to interact/entangle/etc. as described above. As temperature rises (e.g. towards, to or beyond the onset melting temperature), mobility increases and interactions correspondingly increase. Sealing is thereby achieved by heating at or above the softening temperature (optionally at or above the onset melting temperature).

The composites (and constituent polymeric materials herein) are described herein with reference to the softening temperatures and differences between these in the different components (e.g. upper and lower components). Specifically, the lower outer surface component comprising a biodegradable and/or compostable polymeric material has a softening point at least around 15° C. lower than the softening point of the biodegradable and/or compostable polymeric material of the upper outer surface component. The softening point of polymers/blends broadly correlates with the onset melting temperature and melting temperature of a polymer. For example, a polymer having a high softening temperature will have a correspondingly high onset melting temperature (higher than the softening temperature), while a polymer having a low softening temperature will have a correspondingly low onset melting temperature (lower than the softening temperature). It will be appreciated that the selection of suitable polymer/blend combinations constituting the components in the composite can be made with reference to a comparison of the softening temperatures, the onset melting temperatures and/or the melting temperatures (giving the requisite differences therebetween).

The softening point may be the heat deflection temperature (HDT). Alternatively, the softening point may be the Vicat softening point.

The relative softening points of the polymeric material of the upper outer surface components depend on the polymers/blends thereof used. Polymers/blends should be selected to give the requisite difference in softening points, enabling sealing and processing as described herein (e.g. VFFS processing).

The softening point of the biodegradable and/or compostable polymeric material of the upper outer surface component may be:
at most around 130° C., optionally at most around 125° C., optionally at most around 120° C., optionally at most around 115° C., optionally at most around 110° C., optionally at most around 105° C.; and/or
at least around 55° C., optionally at least around 60° C., optionally at least around 65° C., optionally at least around 70° C., optionally at least around 75° C., optionally at least around 80° C.; and/or
around 55 to 130° C., optionally around 60 to 125° C., optionally around 65 to 120° C., optionally around 70 to 115° C., optionally around 75 to 110° C., optionally around 80 to 105° C.

The softening point of the biodegradable and/or compostable polymeric material of the lower outer surface component may be:
at least around 45° C., optionally at least around 50° C., optionally at least around 55° C., optionally at least around 60° C.; and/or
at most around 85° C., optionally at most around 80° C., optionally at most around 75° C., optionally at most around 70° C.; and/or
around 45 to 85° C., optionally around 50 to 80° C., optionally around 55 to 75° C., optionally around 60 to 70° C., optionally around 65° C.

It has been found that substantially planar composites in which the biodegradable and/or compostable polymeric material of the upper and lower outer surface components have a softening point in these ranges are particularly effective for use in a form fill sealing package. If the biodegradable and/or compostable polymeric material of the lower outer surface component has too low a softening point, then it tends to melt at conventional form fill sealing temperatures which leads to undesired flow of the material during form fill sealing. If, conversely, the biodegradable and/or compostable polymeric material of the lower outer surface component has too high a softening point, then more thermal energy is needed in order to give rise to softening.

In some implementations, higher softening points are appropriate. For example, composites comprising PVOH and PGA, which have high softening points, may permit higher ranges of softening points for the upper and lower outer surface components. Where higher softening points are appropriate, the softening point of the biodegradable and/or compostable polymeric material of the upper outer surface component may be:
at most around 210° C., optionally at most around 190° C., optionally at most around 170° C., optionally at most around 150° C.; and/or
at least around 80° C., optionally at least around 100° C., optionally at least around 120° C., and/or
around 80 to 210° C., optionally around 100 to 190° C., optionally around 120 to 170° C.

Where higher softening points are appropriate, the softening point of the biodegradable and/or compostable polymeric material of the lower outer surface component may be:
at most around 195° C., optionally at most around 175° C., optionally at most around 155° C., optionally at most around 135° C.; and/or
at least around 65° C., optionally at least around 85° C., optionally at least around 105° C., and/or
around 65 to 195° C., optionally around 85 to 175° C., optionally around 105 to 155° C.

The softening point of the biodegradable and/or compostable polymeric material of the lower outer surface component may be, in comparison to the softening point of the biodegradable and/or compostable polymeric material of the upper outer surface component:
at least around 20° C. lower, optionally at least around 25° C. lower, optionally at least around 30° C. lower, optionally at least around 35° C. lower, optionally at least around 40° C. lower, optionally at least around 45° C. lower, optionally at least around 50° C. lower, optionally at least around 55° C. lower; and/or
at most around 165° C. lower, optionally at most around 145° C. lower, optionally at most around 125° C. lower, optionally at most around 105° C. lower, optionally at most around 100° C. lower, optionally at most around 95° C. lower, optionally at most around 90° C. lower, optionally at most around 85° C. lower, optionally at most around 80° C. lower, optionally at most around 75° C. lower, optionally at most around 70° C. lower, optionally at most around 65° C. lower; and/or
around 15 to 165° C. lower, optionally around 15 to 145° C. lower, optionally around 15 to 125° C. lower, optionally around 15 to 105° C. lower, optionally around 20 to 100° C. lower, optionally around 25 to 95° C. lower, optionally around 30 to 90° C. lower, optionally around 35 to 85° C. lower, optionally around 40 to 80° C. lower, optionally around 45 to 75° C. lower, optionally around 50 to 70° C. lower, optionally around 55 to 65° C. lower, optionally around 60° C. lower.

The melting point (e.g. onset melting point) of the biodegradable and/or compostable polymeric material of the upper outer surface component may be:
at most around 170° C., optionally at most around 165° C., optionally at most around 160° C., optionally at most around 155° C., optionally at most around 150° C., optionally at most around 145° C.; and/or
at least around 110° C., optionally at least around 115° C., optionally at least around 120° C., optionally at least around 125° C., optionally at least around 130° C., optionally at least around 135° C.; and/or
around 110 to 170° C., optionally around 115 to 165° C., optionally around 120 to 160° C., optionally around 125 to 155° C., optionally around 130 to 150° C., optionally around 135 to 145° C., optionally around 140° C.

The melting point (e.g. onset melting point) of the biodegradable and/or compostable polymeric material of the lower outer surface component may be:
at least around 50° C., optionally at least around 55° C., optionally at least around 60° C., optionally at least around 65° C., optionally at least around 70° C., optionally at least around 75° C.; and/or
at most around 130° C., optionally at most around 125° C., optionally at most around 120° C., optionally at most around 115° C., optionally at most around 110° C., optionally at most around 105° C.; and/or
around 50 to 130° C., optionally around 55 to 125° C., optionally around 60 to 120° C., optionally around 65 to 115° C., optionally around 70 to 110° C., optionally around 75 to 105° C., optionally around 80 to 100° C.

The melting point of the biodegradable and/or compostable polymeric material of the lower outer surface component may be, in comparison to the melting point of the biodegradable and/or compostable polymeric material of the upper outer surface component:
at least around 15° C. lower, optionally at least around 20° C. lower, optionally at least around 25° C. lower, optionally at least around 30° C. lower, optionally at least around 35° C. lower, optionally at least around 40° C. lower, optionally at least around 45° C. lower, optionally at least around 50° C. lower, optionally at least around 55° C. lower; and/or
at most around 105° C. lower, optionally at most around 100° C. lower, optionally at most around 95° C. lower, optionally at most around 90° C. lower, optionally at most around 85° C. lower, optionally at most around 80° C. lower, optionally at most around 75° C. lower, optionally at most around 70° C. lower, optionally at most around 65° C. lower; and/or
around 15 to 105° C. lower, optionally around 20 to 100° C. lower, optionally around 25 to 95° C. lower, optionally around 30 to 90° C. lower, optionally around 35 to 85° C. lower, optionally around 40 to 80° C. lower, optionally around 45 to 75° C. lower, optionally around 50 to 70° C. lower, optionally around 55 to 65° C. lower, optionally around 60° C. lower.

The melting point of polymeric materials is higher than the softening point, and it has been found that a difference in melting point between the biodegradable and/or compostable polymeric materials of the upper and lower outer surface components often approximately correlates to a difference in softening point. It has thus been found that substantially planar composites in which the biodegradable and/or compostable polymeric material of the upper and lower outer surface components have such a difference in melting point are optimal for form fill sealing for similar reasons to those described above.

The glass transition temperature of the biodegradable and/or compostable polymeric material of the upper outer surface component may be:
at least around −35° C.;
at most around 120° C.; and/or
around −35 to 120° C.

The glass transition temperature of the biodegradable and/or compostable polymeric material of the lower outer surface component may be:
at least around −70° C.;
at most around 65° C.; and/or
around −70 to 65° C.

The substantially planar composite may have a thickness ratio of:
at least around 5:95 upper outer surface component to lower outer surface component, optionally at least around 10:90, optionally at least around 15:85, optionally at least around 20:80, optionally at least around 25:75, optionally at least around 30:70, optionally at least around 35:75, optionally at least around 40:60, optionally at least around 45:55; and/or
at most around 95:5 upper outer surface component to lower outer surface component, optionally at most around 90:10, optionally at most around 85:15, optionally at most around 80:20, optionally at most around 75:25, optionally at most around 70:30, optionally at most around 65:35, optionally at most around 60:40, optionally at most around 55:45; and/or
around 5:95 to 95:5 upper outer surface component to lower outer surface component, optionally around 10:90 to 90:10, optionally around 15:85 to 85:15, optionally around 20:80 to 80:20, optionally around 25:75 to 75:25, optionally around 30:70 to 70:30, optionally around 35:65 to 65:35, optionally around 40:60 to 60:40, optionally around 45:55 to 55:45, optionally around 50:50.

It has been found that such thickness ratios are suitable for form fill sealing, because these provide enough lower outer surface component (thickness) to give rise to a strong seal and enough upper outer surface component to provide a strong, supportive outer surface of a form fill seal package.

The upper outer surface component may comprise a polyester, a polysaccharide, a protein (optionally a casein) or poly(vinyl alcohol) (PVOH) (optionally a polyester or polysaccharide);
optionally wherein the biodegradable and/or compostable polymeric material of the upper outer surface component comprises PVOH, and wherein the substantially planar composite further comprises a compatibilising component (e.g. a compatibilising layer) disposed between the upper outer surface component and the lower outer surface component, optionally wherein the compatibilising component is a bonding agent (such as a hydrogen bond forming agent, cross-linking agent covalent bond-forming agent), such as a dicarboxylic acid, a dialcohol, a maleated copolymer, a peroxide or an isocyanate.

The biodegradable and/or compostable polymeric material of the upper outer surface component may comprise a polyester or copolyester, optionally comprising monomers of the formula:

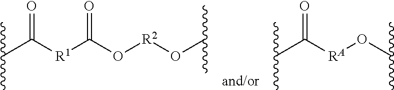

wherein R¹, R² and R^{A} are each independently an optionally substituted C₁₋₉ alkylene, C₆-10 arylene (optionally comprising a phthalic acid residue, such as a terephthalic acid residue) or 5- or 6-membered heteroarylene group (optionally comprising a pyridine dicarboxylic acid or furandicarboxylic acid residue), optionally wherein R¹, R² and R^{A} are each independently an optionally substituted C₁₋₆ alkylene (e.g. C₂, C₄, C₅ or C₆ alkylene) or C₆ arylene group;
optionally wherein R¹ and R² are the same group, and/or wherein R¹ and R² are both alkylene and/or wherein R¹ is alkylene and R² is arylene;
optionally wherein R¹, R² and R^{A} each independently comprise a C₂ backbone chain, optionally comprising an alkyl moiety pendant therefrom, e.g. a C₁, C₂, C₃, C₅ or C₇ alkyl moiety pendant therefrom.

The polyester may be a co-polyester, optionally comprising monomers of the formula:

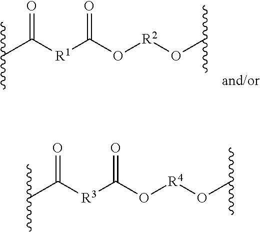

wherein R¹, R², R³ and R⁴ are each independently an optionally substituted C₁₋₆ alkylene, C₆-10 arylene or 5- or 6-membered heteroarylene group;
optionally wherein R¹ is an optionally substituted C₆ arylene or 5- or 6-membered heteroarylene group and R², R³ and R⁴ are each independently an optionally substituted C₄ alkylene group;
optionally wherein the polyester is poly(butylene adipate-co-terephthalate) (PBAT), poly(butyrate adipate furandicarboxylate) (PBAF, e.g. 2,5-PBAF), poly(butyrate adipate pyridinedicarboxylate) (PBAP, e.g. 2,4-PBAP or 2,5-PBAP).

The polyester may be poly(butylene succinate) (PBS), poly(glycolic acid) (PGA) or a poly(hydroxyalkanoate) (PHA), optionally a poly(hydroxybutyrate) (PHB) (such as poly(3-hydroxybutyrate-co-3-hydroxyhexanoate) (PHBH), poly(3-hydroxybutyrate-co-3-hydroxyvalerate) (PHBV), poly(3-hydroxybutyrate-co-3-hydroxyoctanoate) (PHBO) or poly(3-hydroxybutyrate-co-3-hydroxydecanoate) (PHBD)) or poly(3-hydroxyvalerate-co-3-hydroxyhexanoate) (PHVH).

The upper outer surface component may comprise a polysaccharide, optionally comprising monomers of formula:

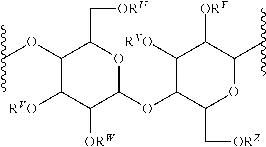

wherein R^{U}, R^{V}, R^{W}, R^{X}, R^{Y}, R^{Z} are each independently H or C(O)R^{T}, wherein R^{T} is optionally substituted C₁₋₆ alkyl, optionally C₁₋₃ alkyl;
optionally wherein the polysaccharide is cellulose or a cellulose derivative (such as cellulose acetate, cellulose butyrate or cellulose propionate).

It has been found that various polymers described above are biodegradable and/or compostable, whilst having suitable softening points for use in the implementations herein (e.g. VFFS processing).

The biodegradable and/or compostable polymeric material of the upper outer surface component may comprise a branched polymer, optionally having a level of branching sufficient to give the polymeric material of the lower outer surface component the softening point lower than the softening point of the biodegradable and/or compostable polymeric material of the upper outer surface component.

Branching can affect the softening point of a polymer and selection of constituent polymers with appropriate branching levels can thereby be used to achieve the requisite softening points for use herein.

The biodegradable and/or compostable polymeric material of the upper outer surface component may comprise a polymeric blend of two or more different polymers.

The polymeric blend of the upper outer surface component may comprise a high-softening-point biodegradable and/or compostable polymer and/or a plasticising biodegradable and/or compostable polymer (optionally both, optionally wherein the high-softening-point biodegradable and/or compostable polymer has a higher softening point than the plasticising biodegradable and/or compostable polymer).

It has been found that such blends are particularly advantageous for use in the upper outer surface component. The high-softening-point biodegradable and/or compostable polymer gives the overall blend a suitably high softening point, whilst the plasticising biodegradable and/or compostable polymer improves the processability of the overall blend. For example, neat high-softening-point biodegradable and/or compostable polymers are often difficult to process due to low melt strength, lower viscosity, high processing temperatures and/or may be tacky/sticky for a prolonged time following an extrusion process (and thus unsuitable for subsequent processing steps such as form fill sealing). However, blending such high-softening-point biodegradable and/or compostable polymers with plasticising polymers can enable their use in subsequent processing steps substantially without suffering the aforementioned disadvantages.

The polymeric blend of the upper outer surface component may comprise:
substantially crystalline regions of the high-softening-point biodegradable and/or compostable polymer; and
substantially amorphous regions comprising the high-softening-point biodegradable and/or compostable polymer and the plasticising biodegradable and/or compostable polymer.

The polymeric blend of the upper outer surface component may comprise a ratio of:
at least around 5:95 high-softening-point biodegradable and/or compostable polymer to plasticising biodegradable and/or compostable polymer, optionally at least around 25:75, optionally at least around 30:70, optionally at least around 35:65, optionally at least around 40:60, optionally at least around 45:55; and/or
at most around 95:5 high-softening-point biodegradable and/or compostable polymer to plasticising biodegradable and/or compostable polymer, optionally at least around 75:25, optionally at least around 70:30, optionally at least around 65:35, optionally at least around 60:40, optionally at least around 55:45; and/or
around 5:95 to 95:5 high-softening-point biodegradable and/or compostable polymer to plasticising biodegradable and/or compostable polymer, optionally around 25:75 to 75:25, optionally around 30:70 to 70:30, optionally around 35:65 to 65:35, optionally around 40:60 to 60:40, optionally around 45:55 to 55:45, optionally around 50:50;
   based on the weights of said high-softening-point biodegradable and/or compostable polymer and plasticising biodegradable and/or compostable polymer in the polymeric blend.

The high-softening-point biodegradable and/or compostable polymer may be a PHA, optionally a PHB (such as PHBH, PHBV, PHBO or PHBD) or PHVH.

The plasticising biodegradable and/or compostable polymer may be PBSA, PBAT or the like (optionally PBAT). PBAT may be present with other materials (e.g. starch, fillers or other materials), as described above.

The polymeric blend of the upper outer surface component may comprise a PHA, optionally a PHB (such as PHBH, PHBV, PHBO or PHBD) or PHVH.

The polymeric blend of the upper outer surface component may comprise PBAT.

The polymeric blend of the upper outer surface component may comprise a ratio of:
at least around 5:95 PHA to PBAT, optionally at least around 25:75; optionally at least around 30:70, optionally at least around 35:65, optionally at least around 40:60, optionally at least around 45:55; and/or
at most around 95:5 PHA to PBAT, optionally at least around 75:25, optionally at least around 70:30, optionally at least around 65:35, optionally at least around 60:40, optionally at least around 55:45; and/or
around 5:95 to 95:5 PHA to PBAT, optionally around 25:75 to 75:25, optionally around 30:70 to 70:30, optionally around 35:65 to 65:35, optionally around 40:60 to 60:40, optionally around 45:55 to 55:45, optionally around 50:50;
   based on the weights of said PHA and PBAT in the polymeric blend.

The polymeric blend of the upper outer surface component may comprise:
substantially crystalline regions of PHA; and
substantially amorphous regions comprising PHA and PBAT.

The polymeric blend of the upper outer surface component may have a glass transition temperature T_{g} in Kelvin such that the reciprocal of T_{g} for the polymeric blend is lower than the sum of the weight fractions of each polymer in the polymeric blend over the glass transition temperature of each polymer in the polymeric blend, in Kelvin;
optionally wherein

$$\frac{1}{{T}_{g}}$$

is at least around 1% lower, optionally around 2% lower, optionally around 3% lower, optionally around 4% lower;
optionally determined by the following equation:

$$\frac{1}{{T}_{g}} < {\sum }_{i = 1}^{n} \frac{{w}_{i}}{{T}_{g , i}}$$

wherein wᵢ (e.g. w₁ and w₂) is the weight fractions of the ith polymer in the polymeric blend, T_{g,i} (e.g. T_{g,1} and T_{g,2}) are the glass transition temperatures in Kelvin of the ith polymer in the polymeric blend and n is the number of different polymers in the polymeric blend.

The biodegradable and/or compostable polymeric material of the upper outer surface component may be compatible with the biodegradable and/or compostable polymeric material of the lower outer surface component.

The biodegradable and/or compostable polymeric material of the lower outer surface component may comprise a polyester, a polysaccharide or a polypeptide (e.g. a casein).

The biodegradable and/or compostable polymeric material of the lower outer surface component may be a heat sealable polymeric material, optionally wherein the polymeric material is heat sealable at a temperature of:
at least around 45° C., optionally at least around 50° C., optionally at least around 55° C., optionally at least around 60° C.; and/or
at most around 85° C., optionally at most around 80° C., optionally at most around 75° C., optionally at most around 70° C.; and/or
around 45 to 85° C., optionally around 50 to 80° C., optionally around 55 to 75° C., optionally around 60 to 70° C., optionally around 65° C.

Where higher softening points are appropriate, the polymeric material of the lower outer surface component may be heat sealable at a temperature of:
at most around 195° C., optionally at most around 175° C., optionally at most around 155° C., optionally at most around 135° C.; and/or
at least around 65° C., optionally at least around 85° C., optionally at least around 105° C., and/or
around 65 to 195° C., optionally around 85 to 175° C., optionally around 105 to 155° C.

The biodegradable and/or compostable polymeric material of the lower outer surface component may comprise a polymeric blend.

The polymeric blend of the lower outer surface component may comprise PBAT, PBSA and/or PCL; optionally PBSA and/or PCL (optionally both). Here, it will be appreciated that PBAT (and other similar polymers) has a high heat sealing temperature (e.g. softening point/melting onset point, etc.) and so may be suitable in implementations where the upper outer surface component has a higher softening point (i.e. at least around 15° C. higher). In such implementations, the upper outer surface component may comprise, for example, PGA, PVOH and the like.

The polymeric blend of the lower outer surface component may be a heat sealable polymeric material, optionally wherein the polymeric blend is heat sealable at a temperature of:
at least around 45° C., optionally at least around 50° C., optionally at least around 55° C., optionally at least around 60° C.; and/or
at most around 85° C., optionally at most around 80° C., optionally at most around 75° C., optionally at most around 70° C.; and/or
around 45 to 85° C., optionally around 50 to 80° C., optionally around 55 to 75° C., optionally around 60 to 70° C., optionally around 65° C.

Where higher softening points are appropriate, the polymeric blend of the lower outer surface component may be heat sealable at a temperature of:
at most around 195° C., optionally at most around 175° C., optionally at most around 155° C., optionally at most around 135° C.; and/or
at least around 65° C., optionally at least around 85° C., optionally at least around 105° C., and/or
around 65 to 195° C., optionally around 85 to 175° C., optionally around 105 to 155° C.

The heat sealable polymeric material may comprise a polyester, a polysaccharide or a polypeptide (e.g. a casein).

The biodegradable and/or compostable polymeric material of the lower outer surface component may comprise a polyester, optionally comprising monomers of the formula:

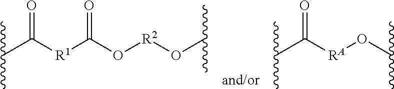

wherein R¹, R² and R^{A} are each independently an optionally substituted C₁₋₉ alkylene, C₆-10 arylene or 5- or 6-membered heteroarylene group;
optionally wherein R^{A} is an optionally substituted C₂₋₅ alkylene group;
optionally wherein the polyester is poly(caprolactone) (PCL) or poly(lactic acid) (PLA).

The polyester may be a co-polyester comprising monomers of the formula:

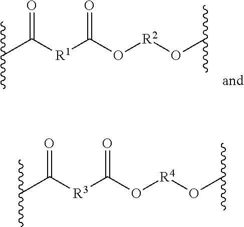

wherein R¹, R², R³ and R⁴ are each independently an optionally substituted C₁₋₉ alkylene (e.g. C₂, C₄ or C₈), C₆₋₁₀ arylene (optionally comprising a phthalic acid residue, such as a terephthalic acid residue) or 5- or 6-membered heteroarylene (optionally comprising a pyridine dicarboxylic acid or furandicarboxylic acid residue) group;
optionally wherein R¹, R², R³ and R⁴ are each independently an optionally substituted C₂₋₄ alkylene group, a C₆ arylene or 5- or 6-membered heteroarylene group;
optionally wherein the co-polyester is poly(butylene succinate co-adipate) (PBSA), PBAT, poly(butylene succinate-co-terephthalate) (PBST), 2,5-PBAF, 2,5-PBAP or 2,4-PBAP.

The co-polyester may be poly(butylene sebacate-co-terephthalate (PBSeT).

The biodegradable and/or compostable polymeric material of the lower outer surface component may comprise native starch or thermoplastic starch (TPS).

It has been found that the various polymers and polymeric blends described above are biodegradable and/or compostable, whilst having suitable softening points for use in the lower outer surface component of a substantially planar composite.

The biodegradable and/or compostable polymeric material of the lower outer surface component may comprise a softening temperature lowering agent, optionally a monomeric, oligomeric (e.g. up to about 10 monomer units) or low molecular weight plasticizer, optionally caprolactone.

The upper outer surface component polymeric material may have a higher average molecular weight than the lower outer surface component polymeric material, the polymeric materials otherwise (than molecular weight) being the same, and wherein the average molecular weights are sufficient to give the polymeric material of the lower outer surface component the softening point lower than the softening point of the biodegradable and/or compostable polymeric material of the upper outer surface component.

The biodegradable and/or compostable polymeric material of the upper and lower outer surface components may each independently have a crystallinity of:
at least around 5%, optionally at least around 10%, optionally at least around 15%, optionally at least around 15%, optionally at least around 15%, optionally at least around 15%; and/or
at most around 60%, optionally at most around 55%, optionally at most around 50%; and/or
around 5 to 60%, optionally around 10 to 55%, optionally around 15 to 50%.

The substantially planar composite may further comprise a plasticiser, optionally wherein the plasticiser comprises one or more hydrophobic regions and one or more hydrophilic regions.

The substantially planar composite may further comprise a filler, optionally:
(a) an inorganic filler, optionally a metal hydroxide (such as magnesium hydroxide), a metal carbonate (such as calcium carbonate), silica, talc, wollastonite or a nanofiller; or
(b) an organic filler, optionally a flour, a native starch, a cellulosic powder or a nanofiller.

The upper and lower outer surface components may be adjacent one another, comprising an interface between the upper outer surface component and the lower outer surface component, wherein said interface comprises a mixture of the biodegradable and/or compostable polymeric material of both the upper and lower outer surface component (e.g. as formed by coextrusion of the upper and lower outer surface components).

It has been found that such an interface provides strong adhesion between the upper and lower outer surface components (and/or the core material, if present). Without wishing to be bound by theory, it is believed that this strong adhesion results from entanglement and/or non-covalent bonding (e.g. hydrogen bonding) between the biodegradable and/or compostable materials of the upper and lower surface components within the interface.

The substantially planar composite may further comprise one or more core materials (optionally comprising a layer, e.g. two or more layers, of core material, such as three or more, four or more or five or more layers of core material) disposed between the upper and lower outer surface components. Composites comprising such core materials are depicted in schematic FIG. 3, with the upper, core and lower components being shown in the layers from top to bottom as depicted (3 layer construction depicted). Here, the upper may have a thickness of 15-25%, the core around 70-50% and the lower around 15-25%. For example, the upper may comprise a blend of Resin 1 (PBAT and native starch)/PHBH 50/50. The lower may be PBSA or a blend based on PCL.

The one or more core materials may comprise:
(a) a substantially planar film, comprising PBS, a PHA (such as PHBV, PHBH, PHBO or PHBD), PGA, cellulose, a cellulose derivative (such as cellulose acetate, cellulose butyrate or cellulose propionate), PVOH, a copolymer of PVOH, a polypeptide (e.g. casein), PLA, PBAT, PBSeT, PBST, TPS, PCL or PBSA; and/or
(b) a compatibilising component (e.g. a compatibilising layer), optionally wherein the compatibilising component is a bonding agent (such as a hydrogen bond forming agent, cross-linking agent covalent bond-forming agent), such as a dicarboxylic acid, a dialcohol, a maleated copolymer, a peroxide or an isocyanate).

The substantially planar composite may comprise:
(a) an interface between the upper outer surface component and core material, wherein said interface comprises a mixture of both the biodegradable and/or compostable polymeric material of the upper outer surface component and core material (e.g. as formed by coextrusion of the upper outer surface component and core material); and/or
(b) an interface between the lower outer surface component and core material, wherein said interface comprises a mixture of both the biodegradable and/or compostable polymeric material of the lower outer surface component and core material (e.g. as formed by coextrusion of the lower outer surface component and core material).

The thickness of the upper outer surface component may be:
at least around 5 wt %, optionally at least around 8 wt %, optionally at least around 10 wt %, optionally at least around 12 wt %, optionally at least around 15 wt %; and/or
at most around 40 wt %, optionally at most around 35 wt %, optionally at most around 30 wt %, optionally at most around 28 wt %, optionally at most around 25 wt %; and/or around 5 to 40 wt %, optionally around 8 to 35 wt %, optionally around 10 to 30 wt %, optionally
around 12 to 28 wt %, optionally around 15 to 25 wt %;
   of the total thickness of the substantially planar composite.

The thickness of the lower outer surface component may be:
at least around 5 wt %, optionally at least around 8 wt %, optionally at least around 10 wt %, optionally at least around 12 wt %, optionally at least around 15 wt %; and/or
at most around 40 wt %, optionally at most around 35 wt %, optionally at most around 30 wt %, optionally at most around 28 wt %, optionally at most around 25 wt %; and/or
around 5 to 40 wt %, optionally around 8 to 35 wt %, optionally around 10 to 30 wt %, optionally around 12 to 28 wt %, optionally around 15 to 25 wt %;
   of the total thickness of the substantially planar composite.

The thickness of the core material may be:
at least around 10 wt %, optionally at least around 20 wt %, optionally at least around 30 wt %, optionally at least around 40 wt %, optionally at least around 45 wt %, optionally at least around 50 wt %; and/or
at most around 90 wt %, optionally at most around 85 wt %, optionally at most around 80 wt %, optionally at most around 75 wt %, optionally at most around 70 wt %; and/or
around 10 to 90 wt %, optionally around 20 to 90 wt %, optionally around 30 to 85 wt %, optionally around 40 to 80 wt %, optionally around 45 to 75 wt %, optionally around 50 to 70 wt %;
   of the total thickness of the substantially planar composite.

The core may have:
(a) a Young's modulus of around 50 to 3,000 MPa;
(b) a tensile strength of around 10 to 50 Mpa;
(c) a tensile strain of around 50 to 900%;
(d) a tear strength of around 20 to 200 N·mm⁻¹;
(e) a dart drop impact strength of around 50 to 400 g; and/or
(f) a puncture resistance of around 25 to 300 mJ·mm⁻¹.

It has been found that the inclusion in substantially planar composites of a core, as described above, has various advantages, such as improving the stability of the composites during processing (e.g. form fill sealing), aiding extrusion and/or improving the structural integrity of articles formed from the composite, e.g. form fill seal packages.

The upper and lower outer surface components may be extrudable.

The biodegradable and/or compostable polymeric material of the upper and/or lower outer surface component may be:
(a) home compostable;
(b) soil biodegradable;
(c) industrially compostable; and/or
(d) marine biodegradable.

Flexible substantially planar composites (e.g. having a high flexibility) are suitable for use in a form fill sealing package. For example, the substantially planar composite may have a tensile modulus of at most around 3500 MPa, optionally at most around 3000 MPa, optionally at most around 2500 MPa, optionally at most around 2000 MPa, optionally at most around 1500 MPa, optionally at most around 1300 MPa. Optionally, the substantially planar composite may have a tensile modulus of at least around 50 MPa. Such substantially planar composites are particularly well-suited for form fill sealing applications, e.g. because they can be easily formed into a tubular cylinder as described above.

In this context, the terms “flexible”, “flexibility” and the like are well understood. The flexibility of a material (e.g. a substantially planar composite) may be represented by the tensile modulus of the material. The term “tensile modulus” means the ability of a material to resist bending. When used herein, the tensile modulus of materials may be measured using the assessment set out in ISO 527-3:2018, wherein the tensile modulus is the slope of the tensile curve between 0.05% and 0.25% elongation. A material having a lower tensile modulus has a higher flexibility.

In some implementations, the substantially planar composite does not comprise poly(lactic acid) (PLA).

According to a second aspect of the present disclosure, there is provided a form fill seal packaging material comprising a substantially planar composite, the substantially planar composite comprising:
an upper outer surface component comprising a biodegradable and/or compostable polymeric material; and
a lower outer surface component comprising a biodegradable and/or compostable polymeric material having a softening point at least around 15° C. lower than the softening point of the biodegradable and/or compostable polymeric material of the upper outer surface component.

The form fill seal packaging material may be as defined in relation to the first aspect in the paragraphs above.

According to a third aspect of the present disclosure, there is provided a method of joining one or more substantially planar composites as defined in relation to the first aspect in the paragraphs above or one or more form fill seal packaging materials as defined in relation to the second aspect in the paragraphs above (e.g. joining to form a package), the method comprising:
heating two portions of the biodegradable and/or compostable polymeric material of the lower outer surface component above the softening point of the biodegradable and/or compostable polymeric material of the lower outer surface and preferably below the softening point of the biodegradable and/or compostable polymeric material of the upper outer surface component; and
bringing said portions into contact with one another.

Said heating may be above the softening point and below the melting point (e.g. onset of the melting point) of the biodegradable and/or compostable polymeric material of the lower outer surface component. Heating may be above the onset melting point of the biodegradable and/or compostable polymeric material of the lower outer surface component.

It has been found that heating in this range is particularly optimal for sealing, because partial melting of the biodegradable and/or compostable polymeric material of the lower outer surface component (caused by heating above the melting point) can cause undesired flow of the component during form fill sealing.

It will be appreciated that the method of the third aspect may comprise heating to the temperatures described above in relation to the first and second aspects. Temperature ranges described above may therefore be adopted as heating ranges for this method, mutatis mutandis.

Heating may comprise the use of a heating element, radio-frequency (RF sealing) or an ultrasonic sealing tool.

Said substantially planar composite may have a machine direction and a transverse direction, and said joining may comprise forming:
(a) one or more substantially elongate joints (such as fin seals or lap seals) having a major length in the machine direction; and/or
(b) one or more substantially elongate joints (such as fin seals or lap seals) having a major length in the transverse direction;
optionally wherein the method is carried out with a form fill sealing machine such as a vertical form fill sealing (VFFS) machine or a horizontal form fill sealing (HFFS) machine.

This method is a particularly optimal way of forming sealed packages that can be used in large-scale industrial form fill sealing processes.

According to a fourth aspect of the present disclosure, there is provided a method of forming a substantially planar composite as defined in relation to the first aspect in the paragraphs above or a form fill seal packaging material as defined in relation to the second aspect in the paragraphs above, wherein the method comprises:
extruding the biodegradable and/or compostable polymeric material of the upper outer surface component to form the upper outer surface component;
extruding the biodegradable and/or compostable polymeric material of the lower outer surface component to form the lower outer surface component; and
connecting (e.g. by co-extruding) the upper and lower outer surface components to form the substantially planar composite.

Without wishing to be bound by theory, it is believed that coextrusion gives rise to an interface (as described above) between the upper and lower outer surface components and is thus a particularly optimal way of forming substantially planar composites.

Extruding the biodegradable and/or compostable polymeric material of the upper outer surface component and extruding the biodegradable and/or compostable polymeric material of the lower outer surface component may collectively comprise coextruding the biodegradable and/or compostable polymeric material of the upper outer surface component and the biodegradable and/or compostable polymeric material of the lower outer surface component.

The method may further comprise placing a core material between the upper outer surface component and the lower outer surface component; and said connecting may comprise connecting the upper outer surface component, the lower outer surface component and the core material to form the substantially planar composite.

Connecting the upper outer surface component, the lower outer surface component and the core material may comprise applying an adhesive and joining the upper outer surface component, the lower outer surface component and the core material.

Placing the core material may comprise extruding the core material, optionally co-extruding the core material with the biodegradable and/or compostable polymeric materials of the upper and lower outer surface components.

According to a fifth aspect of the present disclosure, there is provided a method of forming a substantially planar composite as defined in relation to the first aspect in the paragraphs above or a form fill seal packaging material as defined in relation to the second aspect in the paragraphs above, the method comprising:
providing a layer of the biodegradable and/or compostable polymeric material of the upper outer surface component;
providing a layer of the biodegradable and/or compostable polymeric material of the outer surface component; and
laminating the layers together.

Said laminating may comprise joining the layers with adhesive.

The method may further comprise:
providing a core material between the layers forming the upper outer surface component and the lower outer surface component; and
laminating the upper outer surface component layer, the lower outer surface component layer and the core material.

Said laminating may comprise joining the upper outer surface component layer, the lower outer surface component layer and the core material with adhesive.

### EXAMPLES

### Example 1: Heat Sealing of Substantially Planar Composites at Various Temperatures

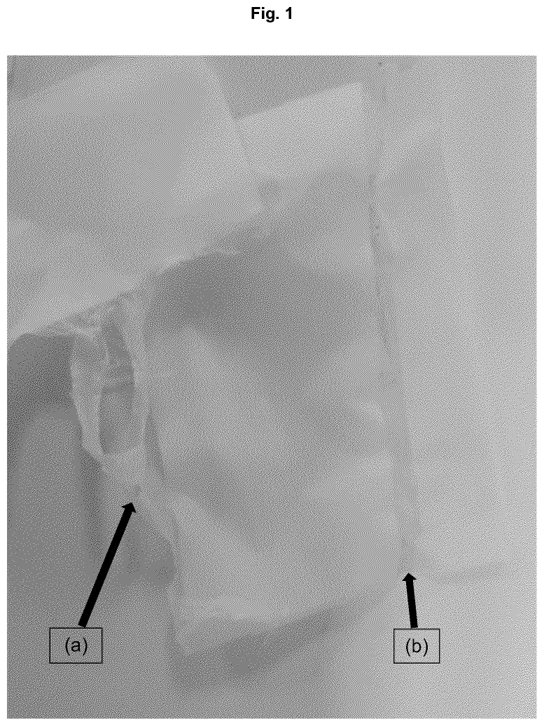

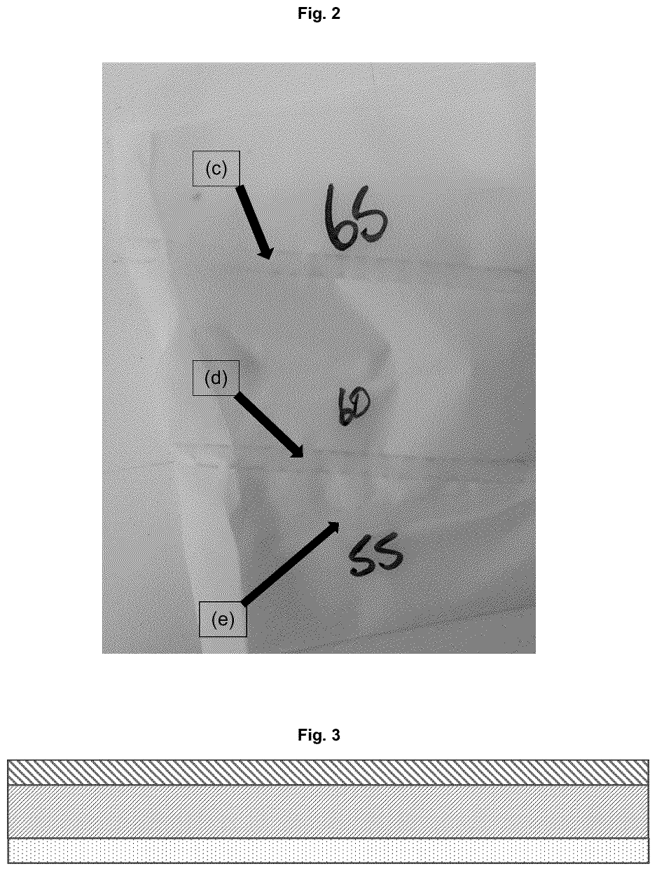

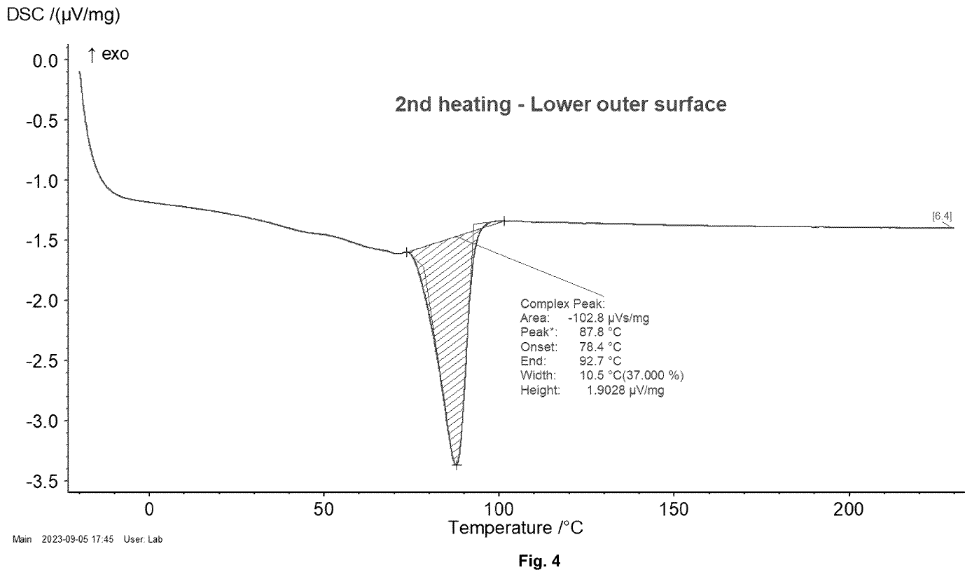

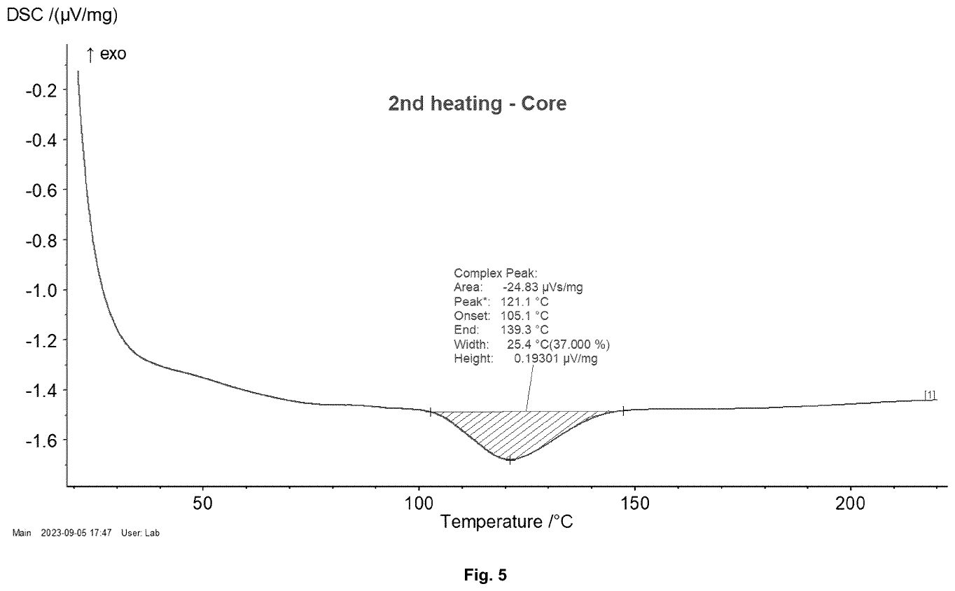

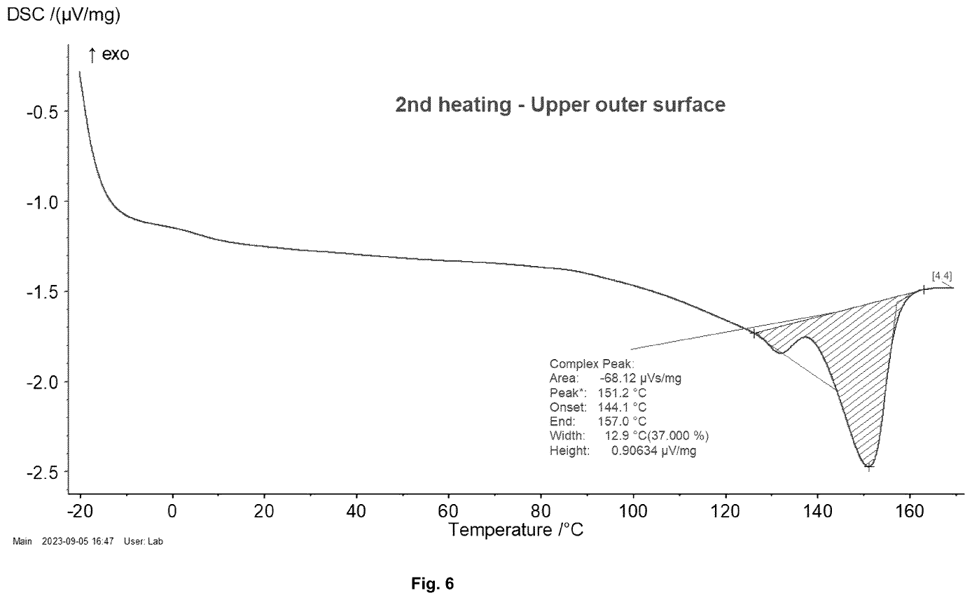

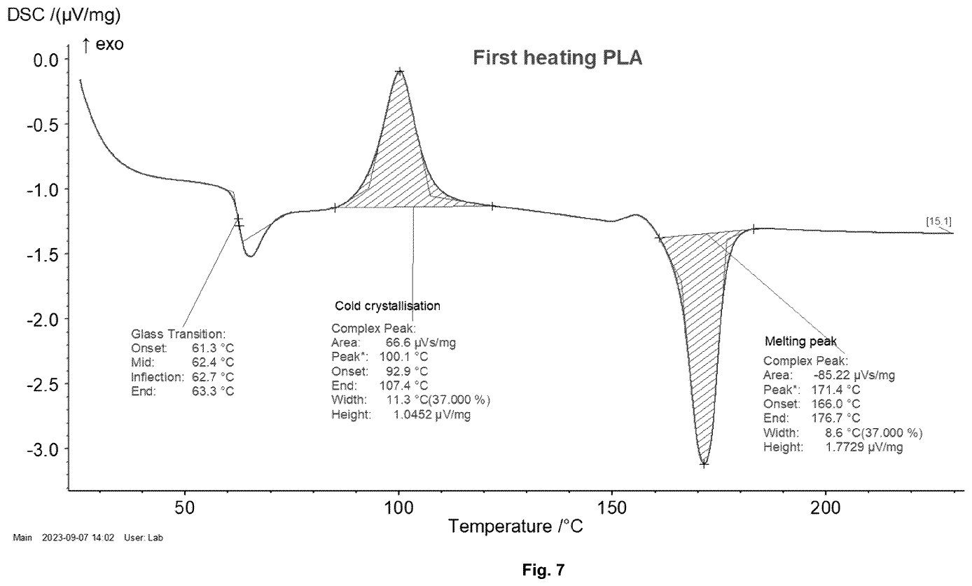

FIG. 1 and FIG. 2 are photographs of substantially planar composites on which heat sealing has been attempted at various temperatures. The sites of attempted sealing are labelled (a) to (e), as discussed below.
(a) This temperature was higher than the melting point of the upper outer surface component and so this component melted during sealing, resulting in a poor seal.
(b) This temperature was higher than the softening point of the upper outer surface component but below its melting point. This resulted in a good seal but some undesirable sticking of the upper outer surface component to the sealing element.
(c), (d) These temperatures were higher than the softening point of the lower outer surface component and lower than the softening point of the upper outer surface component, resulting in a good seal with no/minimal sticking/distortion of the upper outer surface component.
(e) This temperature was below the softening point of the lower outer surface component and so a good seal did not form.

### Example 2: Thermal Analysis of Polymers

Thermal analysis was carried out on various biodegradable and/or compostable polymers. The results are shown in the table below, where the polymers are as defined herein.

Heat deflection temperature (HDT) in each case was measured using the method set out in ISO 75-1:2020 (specifically the B-50 method), as described in the definitions above.

Vicat softening point (Tₛ) in each case was measured using the method set out in ISO 306:2022 (specifically the A120 method), as described in the definitions above.

DSC was used to determine the onset melting point (onset Tₘ) and melting point (Tₘ) as defined in the definitions above, together with the melting point corresponding to the end of the melting point peak (end Tₘ, the highest value in the peak).

| Polymer | HDT | Vicat Tₛ | Onset Tₘ | Tₘ | End Tₘ |
|---|---|---|---|---|---|
| PBS | 90 | — | 111.1 | 117.6 | 123.8 |
| PCL | 53.9 | 59.5 | 53.4 | 60.1 | 66.6 |
| PHBV | 92 | 105 | 150.7 | 155.3 | 162.2 |
| PHBH | 100 | 117 | 135.6 | 152.8 | 160 |
| PLA | 55 | 60 | 148.8 | 158.3 | 166.6 |
| PVOH | (115) | 126.5 | 186.4 | 200.1 | 210.5 |
| PBSA | 57 | 74.6 | 80.8 | 87.8 | 92.6 |
| PBAT | 52 | 58 | 97.9 | 120.8 | 138.7 |
| PBAF | — | — | 73.9 | 102.5 | 109.6 |

(approximate)

### Example 3: Thermal Analysis of the Components of a Substantially Planar Composite

Thermal analysis was carried out on a substantially planar composite. This comprised a lower outer surface component of PBSA, a core of PBAT/native starch, and an upper outer surface component of a 50:50 blend of PHBH:PBAT/native starch.

HDT, Vicat Tₛ, onset Tₘ, Tₘ, and end Tₘ were measured as described in Example 2 above. The results are shown below.

| Component | HDT | Vicat Tₛ | Onset Tₘ | Tₘ | End Tₘ |
|---|---|---|---|---|---|
| Lower | 57 | 74.6 | 78.4 | 87.8 | 92.7 |
| Core | 52 | 57.9 | 105.1 | 121.1 | 139.3 |
| Upper | 85 | 103.9 | 144.1 | 151.2 | 157.0 |

### Example 4: Effect on Blending Composition on Processability

### Materials

Composites were prepared according to the following compositions:

| A (lower outer surface | | A (upper outer surface |
|---|---|---|
| component) | B (Core) | component) |
| PBAT | PHA (30%) | PBAT |
| PBAT | PHA (50%) | PBAT |
| PBAT | PHA (80%) | PBAT |
| PBAT | PHA 100% | PBAT |
| PBAT | PBAT | PHA (30%) |
| PBAT | PBAT | PHA (50%) |
| PBAT | PBAT | PHA (80%) |
| PBAT | PBAT | PHA 100% |

The composite materials exemplified herein, including the polymeric materials making up the upper and lower outer surface components thereof, are certified as compostable.

### Method

ABA multilayer films (having the same material as upper and lower outer surface components, and a different material as a core) with PBAT/PHA/PBAT were blown.

ABB multilayer films with (having the same material as a lower outer surface component and a core, and a different material as an upper outer surface component) PBAT/PBAT/PHA were blown.

All structures were extruded successfully. Films were produced as a collapsed tube, rather than being slit/cut and re-rolled.

In the AAB structure, PHA was tried on both upper/lower component. Both were extruded successfully. Opening the resulting collapsed tube with the PHA in the upper was more facile.

### Example 5: Production of Multilayer Substantially Planar Composites Via Film Extrusion at a Larger Scale for VFFS

### Materials

Resins used:
Resin 1 (native starch/PBAT),
Resin 2 (PBSA),
Resin 3 (PHA),
TiO2 white in PBAT masterbatch (MB),
Resin 4 (Erucamide in PBAT slip masterbatch)

### Method/Timeline

Purge: purge out PE with Resin 1 in all layers,
Extruders and die set at 160° C. in all zones,
Produced films had a thickness of 33 μm
Structure 1: Resin 1 with white MB in core, 9% wt
Structure 2: MB stopped, Resin 2 on inside bubble skin Resin 1 in core and upper outer surface component
Structure 3: Resin 2 in lower outer surface component, Resin 1 in core, Resin 1/Resin 3 (50:50) in upper outer surface component
Structure 4: Resin 2 & 4% wt Resin 4 in lower outer surface component, Resin 1 in core, Resin 1/Resin 3 (50:50) in upper outer surface component
Structure 5: Resin 2 & 4% wt Resin 4 in lower outer surface component, Resin 1/Resin 3 (50:50) in core and upper outer surface component
Structure 6: Resin 2 & 4% wt Resin 4 in lower outer surface component, Resin 1 in core, Resin 3 (100%) in upper outer surface component

The composite materials exemplified herein, including the polymeric materials making up the upper and lower outer surface components thereof, are certified as compostable.

### DISCUSSION

Structure 1: not relevant
Structure 2: seal window not wide enough
Structure 3: hissing on take off rolls, and dropped bubble due to Resin 2 inside adhesion-processing limitation
Structure 4: wide seal window, good pierce force, okay clarity very soft in melt, takes 1-2 hours to solidify. Worry that slip would interfere with adhesion unfounded
Structure 5: wide seal window, poor pierce, okay clarity. Even softer in the melt than previous structures but a little more rigid once crystallised
Structure 6: gives greater clarity, but stickier on rollers-processing limitation
   Resin 3 enhances seal window.
   Slip is typically needed in inner layer to prevent premature adhesion/get over processing limitation
   Resin 3 in upper outer surface component can detract from processing.
   Extra Resin 3 in core reduces pierce strength, with negligible improvement in seal temperature.
   Minimising Resin 3 loading is advantageous from cost perspective

The disclosure also comprises the following clauses, which may be claimed:
1. A substantially planar composite suitable for use in a form fill sealing package, the substantially planar composite comprising:
   an upper outer surface component comprising a biodegradable and/or compostable polymeric material; and
   a lower outer surface component comprising a biodegradable and/or compostable polymeric material having a softening point at least around 15° C. lower than the softening point of the biodegradable and/or compostable polymeric material of the upper outer surface component.
2. The substantially planar composite according to clause 1, wherein the softening point is the heat deflection temperature (HDT).
3. The substantially planar composite according to clause 1, wherein the softening point is the Vicat softening point.
4. The substantially planar composite according to any preceding clause, wherein the softening point of the biodegradable and/or compostable polymeric material of the upper outer surface component is:
   (A) at most around 130° C., optionally at most around 125° C., optionally at most around 120° C., optionally at most around 115° C., optionally at most around 110° C., optionally at most around 105° C.; and/or
      at least around 55° C., optionally at least around 60° C., optionally at least around 65° C., optionally at least around 70° C., optionally at least around 75° C., optionally at least around 80° C.; and/or
      around 55 to 130° C., optionally around 60 to 125° C., optionally around 65 to 120° C., optionally around 70 to 115° C., optionally around 75 to 110° C., optionally around 80 to 105° C.; or
   (B) at most around 210° C., optionally at most around 190° C., optionally at most around 170° C., optionally at most around 150° C.; and/or
      at least around 80° C., optionally at least around 100° C., optionally at least around 120° C., and/or
      around 80 to 210° C., optionally around 100 to 190° C., optionally around 120 to 170° C.
5. The substantially planar composite according to any preceding clause, wherein the softening point of the biodegradable and/or compostable polymeric material of the lower outer surface component is:
   (A) at least around 45° C., optionally at least around 50° C., optionally at least around 55° C., optionally at least around 60° C.; and/or
      at most around 85° C., optionally at most around 80° C., optionally at most around 75° C., optionally at most around 70° C.; and/or
      around 45 to 85° C., optionally around 50 to 80° C., optionally around 55 to 75° C., optionally around 60 to 70° C., optionally around 65° C.; or
   (B) at most around 195° C., optionally at most around 175° C., optionally at most around 155° C., optionally at most around 135° C.; and/or
      at least around 65° C., optionally at least around 85° C., optionally at least around 105° C., and/or
      around 65 to 195° C., optionally around 85 to 175° C., optionally around 105 to 155° C.
6. The substantially planar composite according to any preceding clause, wherein the softening point of the biodegradable and/or compostable polymeric material of the lower outer surface component is, in comparison to the softening point of the biodegradable and/or compostable polymeric material of the upper outer surface component:
   at least around 20° C. lower, optionally at least around 25° C. lower, optionally at least around 30° C. lower, optionally at least around 35° C. lower, optionally at least around 40° C. lower, optionally at least around 45° C. lower, optionally at least around 50° C. lower, optionally at least around 55° C. lower; and/or
   at most around 165° C. lower, optionally at most around 145° C. lower, optionally at most around 125° C. lower, optionally at most around 105° C. lower, optionally at most around 100° C. lower, optionally at most around 95° C. lower, optionally at most around 90° C. lower, optionally at most around 85° C. lower, optionally at most around 80° C. lower, optionally at most
   around 75° C. lower, optionally at most around 70° C. lower, optionally at most around 65° C. lower; and/or around 15 to 165° C. lower, optionally around 15 to 145° C. lower, optionally around 15 to 125° C. lower, optionally around 15 to 105° C. lower, optionally around 20 to 100° C. lower, optionally around 25 to 95° C. lower, optionally around 30 to 90° C. lower, optionally around 35 to 85° C. lower, optionally around 40 to 80° C. lower, optionally around 45 to 75° C. lower, optionally around 50 to 70° C. lower, optionally around 55 to 65° C. lower, optionally around 60° C. lower.
7. The substantially planar composite according to clause 1, wherein:
   (a) the softening point of the biodegradable and/or compostable polymeric material of the upper outer surface component is around 55 to 130° C., optionally around 60 to 125° C., optionally around 65 to 120° C., optionally around 70 to 115° C., optionally around 75 to 110° C., optionally around 80 to 105° C.; and
   (b) the softening point of the biodegradable and/or compostable polymeric material of the lower outer surface component is around 45 to 85° C., optionally around 50 to 80° C., optionally around 55 to 75° C., optionally around 60 to 70° C., optionally around 65° C.; and
   (c) the softening point of the biodegradable and/or compostable polymeric material of the lower outer surface component is, in comparison to the softening point of the biodegradable and/or compostable polymeric material of the upper outer surface component:
      around 15 to 105° C. lower, optionally around 20 to 100° C. lower, optionally around 25 to 95° C. lower, optionally around 30 to 90° C. lower, optionally around 35 to 85° C. lower, optionally around 40 to 80° C. lower, optionally around 45 to 75° C. lower, optionally around 50 to 70° C. lower, optionally around 55 to 65° C. lower, optionally around 60° C. lower;
      optionally wherein
      (i) the softening point of the biodegradable and/or compostable polymeric material of the upper outer surface component is around 75 to 110° C.;
      (ii) the softening point of the biodegradable and/or compostable polymeric material of the lower outer surface component is around 55 to 75° C.; and
      (iii) the softening point of the biodegradable and/or compostable polymeric material of the lower outer surface component is, in comparison to the softening point of the biodegradable and/or compostable polymeric material of the upper outer surface component, around 20 to 55° C. lower.
8. The substantially planar composite according to any preceding clause, wherein the melting point (e.g. onset melting point) of the biodegradable and/or compostable polymeric material of the upper outer surface component is:
   at most around 170° C., optionally at most around 165° C., optionally at most around 160° C., optionally at most around 155° C., optionally at most around 150° C., optionally at most around 145° C.; and/or
   at least around 110° C., optionally at least around 115° C., optionally at least around 120° C., optionally at least around 125° C., optionally at least around 130° C., optionally at least around 135° C.; and/or
   around 110 to 170° C., optionally around 115 to 165° C., optionally around 120 to 160° C., optionally around 125 to 155° C., optionally around 130 to 150° C., optionally around 135 to 145° C., optionally around 140° C.
9. The substantially planar composite according to any preceding clause, wherein the melting point (e.g. onset melting point) of the biodegradable and/or compostable polymeric material of the lower outer surface component is:
   at least around 50° C., optionally at least around 55° C., optionally at least around 60° C., optionally at least around 65° C., optionally at least around 70° C., optionally at least around 75° C.; and/or
   at most around 130° C., optionally at most around 125° C., optionally at most around 120° C., optionally at most around 115° C., optionally at most around 110° C., optionally at most around 105° C.; and/or
   around 50 to 130° C., optionally around 55 to 125° C., optionally around 60 to 120° C., optionally around 65 to 115° C., optionally around 70 to 110° C., optionally around 75 to 105° C., optionally around 80 to 100° C.
10. The substantially planar composite according to any preceding clause, wherein the melting point of the biodegradable and/or compostable polymeric material of the lower outer surface component is, in comparison to the melting point of the biodegradable and/or compostable polymeric material of the upper outer surface component:
   optionally at least around 20° C. lower, optionally at least around 25° C. lower, optionally at least around 30° C. lower, optionally at least around 35° C. lower, optionally at least around 40° C. lower, optionally at least around 45° C. lower, optionally at least around 50° C. lower, optionally at least around 55° C. lower; and/or
   at most around 105° C. lower, optionally at most around 100° C. lower, optionally at most around 95° C. lower, optionally at most around 90° C. lower, optionally at most around 85° C. lower, optionally at most around 80° C. lower, optionally at most around 75° C. lower, optionally at most around 70° C. lower, optionally at most around 65° C. lower; and/or
   around 15 to 105° C. lower, optionally around 20 to 100° C. lower, optionally around 25 to 95° C. lower, optionally around 30 to 90° C. lower, optionally around 35 to 85° C. lower, optionally around 40 to 80° C. lower, optionally around 45 to 75° C. lower, optionally around 50 to 70° C. lower, optionally around 55 to 65° C. lower, optionally around 60° C. lower.
11. The substantially planar composite according to any preceding clause, wherein the glass transition temperature of the biodegradable and/or compostable polymeric material of the upper outer surface component is:
   at least around −35° C.;
   at most around 120° C.; and/or
   around −35 to 120° C.
12. The substantially planar composite according to any preceding clause, wherein the glass transition temperature of the biodegradable and/or compostable polymeric material of the lower outer surface component is:
   at least around −70° C.;
   at most around 65° C.; and/or
   around −70 to 65° C.
13. The substantially planar composite according to any preceding clause, having a thickness ratio of:
   at least around 5:95 upper outer surface component to lower outer surface component, optionally at least around 10:90, optionally at least around 15:85, optionally at least around 20:80, optionally at least around 25:75, optionally at least around 30:70, optionally at least around 35:75, optionally at least around 40:60, optionally at least around 45:55; and/or
   at most around 95:5 upper outer surface component to lower outer surface component, optionally at most around 90:10, optionally at most around 85:15, optionally at most around 80:20, optionally at most around 75:25, optionally at most around 70:30, optionally at most around 65:35, optionally at most around 60:40, optionally at most around 55:45; and/or around 5:95 to 95:5 upper outer surface component to lower outer surface
   component, optionally around 10:90 to 90:10, optionally around 15:85 to 85:15, optionally around 20:80 to 80:20, optionally around 25:75 to 75:25, optionally around 30:70 to 70:30, optionally around 35:65 to 65:35, optionally around 40:60 to 60:40, optionally around 45:55 to 55:45, optionally around 50:50.
14. The substantially planar composite according to any preceding clause, wherein the biodegradable and/or compostable polymeric material of the upper outer surface component comprises a polyester, a polysaccharide, a protein (optionally a casein) or poly(vinyl alcohol) (PVOH) (optionally a polyester or polysaccharide);
   optionally wherein the biodegradable and/or compostable polymeric material of the upper outer surface component comprises PVOH, and wherein the substantially planar composite further comprises a compatibilising component (e.g. a compatibilising layer) disposed between the upper outer surface component and the lower outer surface component, optionally wherein the compatibilising component is a bonding agent (such as a hydrogen bond forming agent, cross-linking agent covalent bond-forming agent), such as a dicarboxylic acid, a dialcohol, a maleated copolymer, a peroxide or an isocyanate.
15. The substantially planar composite according to clause 14, wherein the biodegradable and/or compostable polymeric material of the upper outer surface component comprises a polyester or copolyester, optionally comprising monomers of the formula:

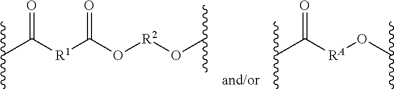

wherein R¹, R² and R^{A} are each independently an optionally substituted C₁₋₉ alkylene, C₆-10 arylene (optionally comprising a phthalic acid residue, such as a terephthalic acid residue) or 5- or 6-membered heteroarylene group (optionally comprising a pyridine dicarboxylic acid or furandicarboxylic acid residue), optionally wherein R¹, R² and R^{A} are each independently an optionally substituted C₁₋₆ alkylene (e.g. C₂, C₄, C₅ or C₆ alkylene) or C₆ arylene group;
optionally wherein R¹ and R² are the same group, and/or wherein R¹ and R² are both alkylene and/or wherein R¹ is alkylene and R² is arylene;
optionally wherein R¹, R² and R^{A} each independently comprise a C₂ backbone chain, optionally comprising an alkyl moiety pendant therefrom, e.g. a C₁, C₂, C₃, C₅ or C₇ alkyl moiety pendant therefrom.
16. The substantially planar composite according to clause 15, wherein the polyester is a co-polyester, optionally comprising monomers of the formula:

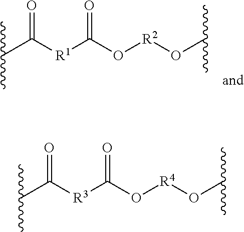

wherein R¹, R², R³ and R⁴ are each independently an optionally substituted C₁₋₆ alkylene, C₆-10 arylene or 5- or 6-membered heteroarylene group;
optionally wherein R¹ is an optionally substituted C₆ arylene or 5- or 6-membered heteroarylene group and R², R³ and R⁴ are each independently an optionally substituted C₄ alkylene group;
optionally wherein the polyester is poly(butylene adipate-co-terephthalate) (PBAT), poly(butyrate adipate furandicarboxylate) (PBAF, e.g. 2,5-PBAF), poly(butyrate adipate pyridinedicarboxylate) (PBAP, e.g. 2,4-PBAP or 2,5-PBAP).
17. The substantially planar composite according to clause 15 or 16, wherein the polyester or copolyester is poly(butylene succinate) (PBS), poly(glycolic acid) (PGA) or a poly(hydroxyalkanoate) (PHA), optionally a poly(hydroxybutyrate) (PHB) (such as poly(3-hydroxybutyrate-co-3-hydroxyhexanoate) (PHBH), poly(3-hydroxybutyrate-co-3-hydroxyvalerate) (PHBV), poly(3-hydroxybutyrate-co-3-hydroxyoctanoate) (PHBO) or poly(3-hydroxybutyrate-co-3-hydroxydecanoate) (PHBD)) or poly(3-hydroxyvalerate-co-3-hydroxyhexanoate) (PHVH).
18. The substantially planar composite according to clause 7 (e.g. according to the optional features of clause 7), wherein the biodegradable and/or compostable polymeric material of the upper outer surface component comprises a polyester or copolyester comprising monomers of the formula:

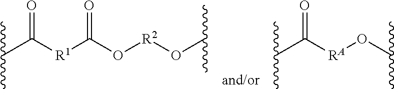

wherein R¹, R² and R^{A} are each independently an optionally substituted C₁₋₉ alkylene, C₆-10 arylene 5- or 6-membered heteroarylene group (e.g. wherein the polyester or copolyester is as defined in clause 16).
19. The substantially planar composite according to clause 7 or 18, wherein the biodegradable and/or compostable polymeric material of the upper outer surface component comprises PBAT, 2,5-PBAF, 2,4-PBAP, 2,5-PBAP, PBS, PGA, a PHA, cellulose, cellulose acetate, cellulose butyrate and/or cellulose propionate (optionally PBAT, PBS and/or a PHA).
20. The substantially planar composite according to clause 14, wherein the upper outer surface component comprises a polysaccharide, optionally comprising monomers of formula:

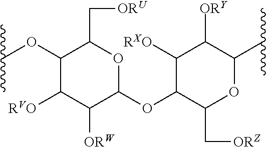

wherein R^{U}, R^{V}, R^{W}, R^{X}, R^{Y}, R^{Z} are each independently H or C(O)R^{T}, wherein R^{T} is optionally substituted C₁₋₆ alkyl, optionally C₁₋₃ alkyl;
   optionally wherein the polysaccharide is cellulose or a cellulose derivative (such as cellulose acetate, cellulose butyrate or cellulose propionate).
21. The substantially planar composite according to any preceding clause, wherein the biodegradable and/or compostable polymeric material of the upper outer surface component comprises a branched polymer, optionally having a level of branching sufficient to give the polymeric material of the lower outer surface component the softening point lower than the softening point of the biodegradable and/or compostable polymeric material of the upper outer surface component.
22. The substantially planar composite according to any preceding clause, wherein the biodegradable and/or compostable polymeric material of the upper outer surface component comprises a polymeric blend of two or more different polymers.
23. The substantially planar composite according to clause 22, wherein the polymeric blend of the upper outer surface component comprises a high-softening-point biodegradable and/or compostable polymer and/or a plasticising biodegradable and/or compostable polymer (optionally both, optionally wherein the high-softening-point biodegradable and/or compostable polymer has a higher softening point than the plasticising biodegradable and/or compostable polymer).
24. The substantially planar composite according to clause 23, wherein the polymeric blend of the upper outer surface component comprises:
   substantially crystalline regions of the high-softening-point biodegradable and/or compostable polymer; and
   substantially amorphous regions comprising the high-softening-point biodegradable and/or compostable polymer and the plasticising biodegradable and/or compostable polymer.
25. The substantially planar composite according to clause 23 or 24, wherein the polymeric blend of the upper outer surface component comprises a ratio of:
   at least around 5:95 high-softening-point biodegradable and/or compostable polymer to plasticising biodegradable and/or compostable polymer, optionally at least around 25:75, optionally at least around 30:70, optionally at least around 35:65, optionally at least around 40:60, optionally at least around 45:55; and/or
   at most around 95:5 high-softening-point biodegradable and/or compostable polymer to plasticising biodegradable and/or compostable polymer, optionally at least around 75:25, optionally at least around 70:30, optionally at least around 65:35, optionally at least around 60:40, optionally at least around 55:45; and/or
   around 5:95 to 95:5 high-softening-point biodegradable and/or compostable polymer to plasticising biodegradable and/or compostable polymer, optionally around 25:75 to 75:25, optionally around 30:70 to 70:30, optionally around 35:65 to 65:35, optionally around 40:60 to 60:40, optionally around 45:55 to 55:45, optionally around 50:50;
based on the weights of said high-softening-point biodegradable and/or compostable polymer and plasticising biodegradable and/or compostable polymer in the polymeric blend.
26. The substantially planar composite according to any one of clauses 23-25, wherein the high-softening-point biodegradable and/or compostable polymer is a PHA, optionally a PHB (such as PHBH, PHBV, PHBO or PHBD) or PHVH.
27. The substantially planar composite according to any one of clauses 23-26, wherein the plasticising biodegradable and/or compostable polymer is PBSA, PBAT or the like (optionally PBAT).
28. The substantially planar composite according to clause 22, wherein the polymeric blend of the upper outer surface component comprises a PHA, optionally a PHB (such as PHBH, PHBV, PHBO or PHBD) or PHVH.
29. The substantially planar composite according to clause 22 or 28, wherein the polymeric blend of the upper outer surface component comprises PBAT.
30. The substantially planar composite according to any one of clauses 22, 28 and 29, wherein the polymeric blend of the upper outer surface component comprises a ratio of:
   at least around 5:95 PHA to PBAT, optionally at least around 25:75; optionally at least around 30:70, optionally at least around 35:65, optionally at least around 40:60, optionally at least around 45:55; and/or
   at most around 95:5 PHA to PBAT, optionally at least around 75:25, optionally at least around 70:30, optionally at least around 65:35, optionally at least around 60:40, optionally at least around 55:45; and/or
   around 5:95 to 95:5 PHA to PBAT, optionally around 25:75 to 75:25, optionally around 30:70 to 70:30, optionally around 35:65 to 65:35, optionally around 40:60 to 60:40, optionally around 45:55 to 55:45, optionally around 50:50;
based on the weights of said PHA and PBAT in the polymeric blend.
31. The substantially planar composite according to any one of clauses 22 or 28-30, wherein the polymeric blend of the upper outer surface component comprises:
   substantially crystalline regions of PHA; and
   substantially amorphous regions comprising PHA and PBAT.
32. The substantially planar composite according to any one of clauses 22-31, wherein the polymeric blend of the upper outer surface component has a glass transition temperature T_{g} in Kelvin such that the reciprocal of T_{g} for the polymeric blend is lower than the sum of the weight fractions of each polymer in the polymeric blend over the glass transition temperature of each polymer in the polymeric blend, in Kelvin;
   optionally wherein

$$\frac{1}{{T}_{g}}$$

is at least around 1% lower, optionally around 2% lower, optionally around 3% lower, optionally around 4% lower;
optionally determined by the following equation:

$$\frac{1}{{T}_{g}} < {\sum }_{i = 1}^{n} \frac{{w}_{i}}{{T}_{g , i}}$$

wherein wᵢ (e.g. w₁ and w₂) is the weight fractions of the ith polymer in the polymeric blend, T_{g},I (e.g. T_{g,1} and T_{g,2}) are the glass transition temperatures in Kelvin of the ith polymer in the polymeric blend and n is the number of different polymers in the polymeric blend.
33. The substantially planar composite according to any preceding clause, wherein the biodegradable and/or compostable polymeric material of the upper outer surface component is compatible with the biodegradable and/or compostable polymeric material of the lower outer surface component.
34. The substantially planar composite according to any preceding clause, wherein the biodegradable and/or compostable polymeric material of the lower outer surface component comprises a polyester, a polysaccharide or a polypeptide (e.g. a casein); optionally a polyester or a polysaccharide.
35. The substantially planar composite according to any preceding clause, wherein the biodegradable and/or compostable polymeric material of the lower outer surface component (optionally the polyester, polysaccharide or polypeptide of clause 34) is a heat sealable polymeric material, optionally wherein the polymeric material is heat sealable at a temperature of:
   (A) at least around 45° C., optionally at least around 50° C., optionally at least around 55° C., optionally at least around 60° C.; and/or
      at most around 85° C., optionally at most around 80° C., optionally at most around 75° C., optionally at most around 70° C.; and/or
      around 45 to 85° C., optionally around 50 to 80° C., optionally around 55 to 75° C., optionally around 60 to 70° C., optionally around 65° C.; or
   (B) at most around 195° C., optionally at most around 175° C., optionally at most around 155° C., optionally at most around 135° C.; and/or
      at least around 65° C., optionally at least around 85° C., optionally at least around 105° C., and/or
      around 65 to 195° C., optionally around 85 to 175° C., optionally around 105 to 155° C.
36. The substantially planar composite according to any preceding clause, wherein the biodegradable and/or compostable polymeric material of the lower outer surface component comprises a polymeric blend.
37. The substantially planar composite according to clause 36, wherein the polymeric blend of the lower outer surface component comprises PBAT, PBSA and/or PCL optionally PBSA and/or PCL (optionally both).
38. The substantially planar composite according to clause 36 or 37, wherein the polymeric blend of the lower outer surface component is a heat sealable polymeric material, optionally wherein the polymeric blend is heat sealable at a temperature of:
   (A) at least around 45° C., optionally at least around 50° C., optionally at least around 55° C., optionally at least around 60° C.; and/or
      at most around 85° C., optionally at most around 80° C., optionally at most around 75° C., optionally at most around 70° C.; and/or
      around 45 to 85° C., optionally around 50 to 80° C., optionally around 55 to 75° C., optionally around 60 to 70° C., optionally around 65° C.; or
   (B) at most around 195° C., optionally at most around 175° C., optionally at most around 155° C., optionally at most around 135° C.; and/or
      at least around 65° C., optionally at least around 85° C., optionally at least around 105° C., and/or
      around 65 to 195° C., optionally around 85 to 175° C., optionally around 105 to 155° C.
39. The substantially planar composite according to any one of clauses 1-33, wherein the biodegradable and/or compostable polymeric material of the lower outer surface component comprises a heat sealable polymeric material, optionally wherein the polymeric material is heat sealable at a temperature of:
   at least around 45° C., optionally at least around 50° C., optionally at least around 55° C., optionally at least around 60° C.; and/or
   at most around 85° C., optionally at most around 80° C., optionally at most around 75° C., optionally at most around 70° C.; and/or
   around 45 to 85° C., optionally around 50 to 80° C., optionally around 55 to 75° C., optionally around 60 to 70° C., optionally around 65° C.
40. The substantially planar composite according to clause 39, wherein the heat sealable polymeric material comprises a polyester, a polysaccharide or a polypeptide (e.g. a casein).
41. The substantially planar composite according to any preceding clause, wherein the biodegradable and/or compostable polymeric material of the lower outer surface component comprises a polyester, optionally comprising monomers of the formula:

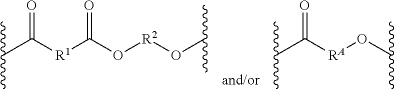

wherein R¹, R² and R^{A} are each independently an optionally substituted C₁₋₉ alkylene, C₆₋₁₀ arylene or 5- or 6-membered heteroarylene group;
   optionally wherein R^{A} is an optionally substituted C₂₋₅ alkylene group;
   optionally wherein the polyester is poly(butylene adipate-co-terephthalate) (PBAT), poly(caprolactone) (PCL) or poly(lactic acid) (PLA); optionally poly(caprolactone) (PCL) or poly(lactic acid) (PLA).
42. The substantially planar composite according to clause 41, wherein the polyester is a co-polyester comprising monomers of the formula:

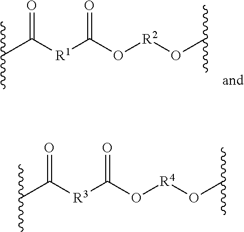

wherein R¹, R², R³ and R⁴ are each independently an optionally substituted C₁₋₉ alkylene (e.g. C₂, C₄ or C₈), C₆₋₁₀ arylene (optionally comprising a phthalic acid residue, such as a terephthalic acid residue) or 5- or 6-membered heteroarylene (optionally comprising a pyridine dicarboxylic acid or furandicarboxylic acid residue) group;
   optionally wherein R¹, R², R³ and R⁴ are each independently an optionally substituted C₂₋₄ alkylene group, a C₆ arylene or 5- or 6-membered heteroarylene group;
   optionally wherein the co-polyester is poly(butylene succinate co-adipate) (PBSA), PBAT, poly(butylene succinate-co-terephthalate) (PBST), 2,5-PBAF, 2,5-PBAP or 2,4-PBAP.
43. The substantially planar composite according to clause 42, wherein the co-polyester is poly(butylene sebacate-co-terephthalate (PBSeT).
44. The substantially planar composite according to any preceding clause, wherein the biodegradable and/or compostable polymeric material of the lower outer surface component comprises native starch and/or thermoplastic starch (TPS), optionally native starch.
45. The substantially planar composite according to any one of clauses 39-44, wherein the heat sealable polymeric material, when present, is a polymeric blend.
46. The substantially planar composite according to clause 45, wherein the polymeric blend of the lower outer surface component comprises PBAT, PBSA and/or PCL; optionally PBSA and/or PCL (optionally both).
47. The substantially planar composite according to any one of clauses 7, 18 or 19, optionally according to clause 7, wherein the biodegradable and/or compostable polymeric material of the lower outer surface component comprises a polyester, optionally comprising monomers of the formula:

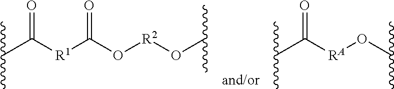

wherein R¹, R² and R^{A} are each independently an optionally substituted C₁₋₆ alkylene, C₆-10 arylene or 5- or 6-membered heteroarylene group.
48. The substantially planar composite according to clause 47, wherein the biodegradable and/or compostable polymeric material of the lower outer surface component comprises PCL, PLA, PBSA, PBAT, PBST, 2,5-PBAF, 2,5-PBAP, 2,4-PBAP, PBSeT and/or starch (optionally native starch or thermoplastic starch, optionally native starch).
49. The substantially planar composite according to any preceding clause, wherein the biodegradable and/or compostable polymeric material of the lower outer surface component comprises a softening temperature lowering agent, optionally caprolactone.
50. The substantially planar composite according to any preceding clause, wherein the upper outer surface component polymeric material has a higher average molecular weight than the lower outer surface component polymeric material, the polymeric materials otherwise (than molecular weight) being the same, and wherein the average molecular weights are sufficient to give the polymeric material of the lower outer surface component the softening point lower than the softening point of the biodegradable and/or compostable polymeric material of the upper outer surface component.
51. The substantially planar composite according to any preceding clause, wherein the biodegradable and/or compostable polymeric material of the upper and lower outer surface components each independently have a crystallinity of:
   at least around 5%, optionally at least around 10%, optionally at least around 15%, optionally at least around 15%, optionally at least around 15%, optionally at least around 15%; and/or
   at most around 60%, optionally at most around 55%, optionally at most around 50%; and/or
   around 5 to 60%, optionally around 10 to 55%, optionally around 15 to 50%.
52. The substantially planar composite according to any preceding clause, further comprising a plasticiser, optionally wherein the plasticiser comprises one or more hydrophobic regions and one or more hydrophilic regions.
53. The substantially planar composite according to any preceding clause, further comprising a filler, optionally:
   (a) an inorganic filler, optionally a metal hydroxide (such as magnesium hydroxide), a metal carbonate (such as calcium carbonate), silica, talc, wollastonite or a nanofiller; or
   (b) an organic filler, optionally a flour, a native starch, a cellulosic powder or a nanofiller.
54. The substantially planar composite according to any preceding clause, wherein the upper and lower outer surface components are adjacent one another, comprising an interface between the upper outer surface component and the lower outer surface component, wherein said interface comprises a mixture of the biodegradable and/or compostable polymeric material of both the upper and lower outer surface component (e.g. as formed by coextrusion of the upper and lower outer surface components).
55. The substantially planar composite according to any one of clauses 1-53, further comprising one or more core materials (optionally comprising a layer, e.g. two or more layers, of core material, such as three or more, four or more or five or more layers of core material) disposed between the upper and lower outer surface components.
56. The substantially planar composite according to clause 55, wherein the one or more core materials comprise:
   (a) a substantially planar film, comprising PBS, a PHA (such as PHBV, PHBH, PHBO or PHBD), PGA, cellulose, a cellulose derivative (such as cellulose acetate, cellulose butyrate or cellulose propionate), PVOH, a copolymer of PVOH, a polypeptide (e.g. a casein), PLA, PBAT, PBSeT, PBST, starch (e.g. native starch or thermoplastic starch, optionally native starch), PCL or PBSA; and/or
   (b) a compatibilising component (e.g. a compatibilising layer), optionally wherein the compatibilising component is a bonding agent (such as a hydrogen bond forming agent, cross-linking agent covalent bond-forming agent), such as a dicarboxylic acid, a dialcohol, a maleated copolymer, a peroxide or an isocyanate).
57. The substantially planar composite according to clause 55 or 56, comprising:
   (a) an interface between the upper outer surface component and core material, wherein said interface comprises a mixture of both the biodegradable and/or compostable polymeric material of the upper outer surface component and core material (e.g. as formed by coextrusion of the upper outer surface component and core material); and/or
   (b) an interface between the lower outer surface component and core material, wherein said interface comprises a mixture of both the biodegradable and/or compostable polymeric material of the lower outer surface component and core material (e.g. as formed by coextrusion of the lower outer surface component and core material).
58. The substantially planar composite according to any one of clauses 55-57, wherein the thickness of the upper outer surface component is:
   at least around 5 wt %, optionally at least around 8 wt %, optionally at least around 10 wt %, optionally at least around 12 wt %, optionally at least around 15 wt %; and/or
   at most around 40 wt %, optionally at most around 35 wt %, optionally at most around 30 wt %, optionally at most around 28 wt %, optionally at most around 25 wt %; and/or
   around 5 to 40 wt %, optionally around 8 to 35 wt %, optionally around 10 to 30 wt %, optionally around 12 to 28 wt %, optionally around 15 to 25 wt %;
of the total thickness of the substantially planar composite.
59. The substantially planar composite according to any one of clauses 55-58, wherein the thickness of the lower outer surface component is:
   at least around 5 wt %, optionally at least around 8 wt %, optionally at least around 10 wt %, optionally at least around 12 wt %, optionally at least around 15 wt %; and/or
   at most around 40 wt %, optionally at most around 35 wt %, optionally at most around 30 wt %, optionally at most around 28 wt %, optionally at most around 25 wt %; and/or
   around 5 to 40 wt %, optionally around 8 to 35 wt %, optionally around 10 to 30 wt %, optionally around 12 to 28 wt %, optionally around 15 to 25 wt %;
of the total thickness of the substantially planar composite.
60. The substantially planar composite according to any one of clauses 55-59, wherein the thickness of the core material is:
   at least around 20 wt %, optionally at least around 30 wt %, optionally at least around 40 wt %, optionally at least around 45 wt %, optionally at least around 50 wt %; and/or
   at most around 90 wt %, optionally at most around 85 wt %, optionally at most around 80 wt %, optionally at most around 75 wt %, optionally at most around 70 wt %; and/or
   around 20 to 90 wt %, optionally around 30 to 85 wt %, optionally around 40 to 80 wt %, optionally around 45 to 75 wt %, optionally around 50 to 70 wt %;
of the total thickness of the substantially planar composite.
61. The substantially planar composite according to any one of clauses 55-60, wherein the core has:
   (a) a Young's modulus of around 50 to 3,000 MPa;
   (b) a tensile strength of around 10 to 50 MPa;
   (c) a tensile strain of around 50 to 900%;
   (d) a tear strength of around 20 to 200 N·mm⁻¹;
   (e) a dart drop impact strength of around 50 to 400 g; and/or
   (f) a puncture resistance of around 25 to 300 mJ·mm⁻¹.
62. The substantially planar composite according to any preceding clause, wherein the upper and lower outer surface components are extrudable.
63. The substantially planar composite according to any preceding clause, wherein the biodegradable and/or compostable polymeric material of the upper and/or lower outer surface component is:
   (a) home compostable;
   (b) soil biodegradable;
   (c) industrially compostable; and/or
   (d) marine biodegradable.
64. The substantially planar composite according to clause 7 (e.g. according to the optional features of clause 7), wherein the biodegradable and/or compostable polymeric material of the upper outer surface component comprises PBS, PHBV, PHBH, PVOH, PBAT and/or native starch, optionally PHBH, PBAT and native starch.
65. The substantially planar composite according to clause 64, wherein the biodegradable and/or compostable polymeric material of the lower outer surface component comprises PCL, PLA, PBSA and/or PBAT, optionally PBSA.
66. The substantially planar composite according to clause 65, further comprising one or more core materials (optionally comprising a layer, e.g. two or more layers, of core material, such as three or more, four or more or five or more layers of core material) disposed between the upper and lower outer surface components;
   wherein the one or more core materials comprise PBAT and native starch.
67. The substantially planar composite according to any preceding clause (optionally according to clause 1, optionally according to clause 2) wherein:
   (a) the biodegradable and/or compostable polymeric material of the upper outer surface component comprises one or more polyesters or copolyesters comprising monomers of the formula:

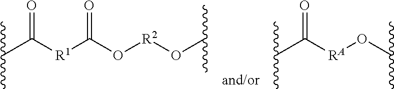

wherein R¹, R² and R^{A} are each independently an optionally substituted C₁₋₉ alkylene, C₆-10 arylene 5- or 6-membered heteroarylene group (e.g. wherein the polyester or copolyester is as defined in clause 16), optionally wherein biodegradable and/or compostable polymeric material of the upper outer surface component comprises PHBH and PBAT; and
(b) the biodegradable and/or compostable polymeric material of the lower outer surface component comprises a polyester, optionally comprising monomers of the formula:

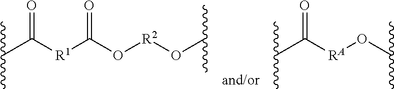

wherein R¹, R² and R^{A} are each independently an optionally substituted C₁₋₆ alkylene, C₆₋₁₀ arylene or 5- or 6-membered heteroarylene group, optionally wherein the polyester is PBSA; and
(c) the softening point of the biodegradable and/or compostable polymeric material of the upper outer surface component is around 75 to 90° C.; and
(d) the softening point of the biodegradable and/or compostable polymeric material of the lower outer surface component is around 45 to 60° C.
68. The substantially planar composite according to any preceding clause (optionally according to clause 1, optionally according to clause 3), wherein:
   (a) the biodegradable and/or compostable polymeric material of the upper outer surface component comprises one or more polyesters or copolyesters comprising monomers of the formula:

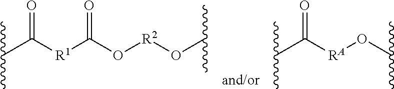

wherein R¹, R² and R^{A} are each independently an optionally substituted C₁₋₉ alkylene, C₆-10 arylene 5- or 6-membered heteroarylene group (e.g. wherein the polyester or copolyester is as defined in clause 16), optionally wherein biodegradable and/or compostable polymeric material of the upper outer surface component comprises PHBH and PBAT; and
(b) the biodegradable and/or compostable polymeric material of the lower outer surface component comprises a polyester, optionally comprising monomers of the formula:

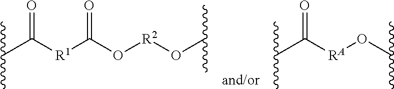

wherein R¹, R² and R^{A} are each independently an optionally substituted C₁₋₆ alkylene, C₆-10 arylene or 5- or 6-membered heteroarylene group, optionally wherein the polyester is PBSA; and
(c) the softening point of the biodegradable and/or compostable polymeric material of the upper outer surface component is around 95 to 110° C.; and
(d) the softening point of the biodegradable and/or compostable polymeric material of the lower outer surface component is around 60 to 85° C.
69. The substantially planar composite according to any preceding clause, wherein the substantially planar composite has a tensile modulus of:
   (a) at most around 3500 MPa, optionally at most around 3000 MPa, optionally at most around 2500 MPa, optionally at most around 2000 MPa, optionally at most around 1500 MPa, optionally at most around 1300 MPa; and/or
   (b) at least around 50 MPa.
70. The substantially planar composite according to any preceding clause, wherein the substantially planar composite does not comprise poly(lactic acid) (PLA).
71. A form fill seal packaging material comprising a substantially planar composite, the substantially planar composite comprising:
   an upper outer surface component comprising a biodegradable and/or compostable polymeric material; and
   a lower outer surface component comprising a biodegradable and/or compostable polymeric material having a softening point at least around 15° C. lower than the softening point of the biodegradable and/or compostable polymeric material of the upper outer surface component.
72. The form fill seal packaging material according to clause 71, wherein the substantially planar composite is as defined in any one of clauses 2-70, optionally as defined in any one of clauses 7, 18, 19, 47 and 48.
73. A method of joining one or more substantially planar composites according to any one of clauses 1-70 (optionally according to any one of clauses 7, 18, 19, 47 and 48) or one or more form fill seal packaging materials according to clause 71 or 72 (e.g. joining to form a package), the method comprising:
   heating two portions of the biodegradable and/or compostable polymeric material of the lower outer surface component above the softening point of the biodegradable and/or compostable polymeric material of the lower outer surface and preferably below the softening point of the biodegradable and/or compostable polymeric material of the upper outer surface component; and
   bringing said portions into contact with one another.
74. The method of clause 73, wherein said heating is above the softening point and below the melting point of the biodegradable and/or compostable polymeric material of the lower outer surface component, optionally wherein (a) said heating is above the onset melting point of the biodegradable and/or compostable polymeric material of the lower outer surface component, and/or (b) said heating comprises the use of a heating element, radio-frequency (RF sealing) or an ultrasonic sealing tool.
75. The method of clause 73 or 74, wherein said substantially planar composite has a machine direction and a transverse direction, and said joining comprises forming:
   (a) one or more substantially elongate joints (such as fin seals or lap seals) having a major length in the machine direction; and/or
   (b) one or more substantially elongate joints (such as fin seals or lap seals) having a major length in the transverse direction;
   optionally wherein the method is carried out with a form fill sealing machine such as a vertical form fill sealing (VFFS) machine or a horizontal form fill sealing (HFFS) machine.
76. A method of forming a substantially planar composite according to any one of clauses 1-70 (optionally according to any one of clauses 7, 18, 19, 47 and 48) or a form fill seal packaging material according to clause 71 or 72, wherein the method comprises:
   extruding the biodegradable and/or compostable polymeric material of the upper outer surface component to form the upper outer surface component;
   extruding the biodegradable and/or compostable polymeric material of the lower outer surface component to form the lower outer surface component; and
   connecting (e.g. by co-extruding) the upper and lower outer surface components to form the substantially planar composite.
77. The method of clause 76, wherein extruding the biodegradable and/or compostable polymeric material of the upper outer surface component and extruding the biodegradable and/or compostable polymeric material of the lower outer surface component collectively comprise coextruding the biodegradable and/or compostable polymeric material of the upper outer surface component and the biodegradable and/or compostable polymeric material of the lower outer surface component.
78. The method of clause 77, further comprising placing a core material between the upper outer surface component and the lower outer surface component; and wherein said connecting comprises connecting the upper outer surface component, the lower outer surface component and the core material to form the substantially planar composite.
79. The method of clause 78, wherein connecting the upper outer surface component, the lower outer surface component and the core material comprises applying an adhesive and joining the upper outer surface component, the lower outer surface component and the core material.
80. The method of clause 78, wherein placing the core material comprises extruding the core material, optionally co-extruding the core material with the biodegradable and/or compostable polymeric materials of the upper and lower outer surface components.
81. A method of forming a substantially planar composite according to any one of clauses 1-70 (optionally according to any one of clauses 7, 18, 19, 47 and 48) or the form fill seal packaging material according to clause 71 or 72, the method comprising:
   providing a layer of the biodegradable and/or compostable polymeric material of the upper outer surface component;
   providing a layer of the biodegradable and/or compostable polymeric material of the outer surface component; and
   laminating the layers together.
82. The method of clause 81, wherein said laminating comprises joining the layers with adhesive.
83. The method according to clause 81, further comprising:
   providing a core material between the layers forming the upper outer surface component and the lower outer surface component; and
   laminating the upper outer surface component layer, the lower outer surface component layer and the core material.
84. The method of clause 83, wherein said laminating comprises joining the upper outer surface component layer, the lower outer surface component layer and the core material with adhesive.

Any listing or discussion of an apparently prior-published document in this specification should not necessarily be taken as an acknowledgement that the document is part of the state of the art or common general knowledge. All references disclosed herein are to be considered to be incorporated herein by reference.

All features discussed herein in respect of any of the methods or products relate to all other methods or products mutatis mutandis. For example, features described in relation to the substantially planar composite of the first aspect apply equally, mutatis mutandis to the form fill seal packaging material of the second aspect; and also the method of joining according to the third aspect, or the methods of forming according to the fourth and fifth aspects, mutatis mutandis.

Those skilled in the art will recognise or be able to ascertain using no more than routine experimentation many equivalents to the specific embodiments described herein. The scope of the present disclosure herein is not intended to be limited to the above description, but rather is as set forth in the appended claims. Those of ordinary skill in the art will appreciate that various changes and modifications to this description may be made without departing from the spirit or scope of the present disclosure.

1.-17. (canceled)

18. A form fill seal packaging material comprising a substantially planar composite, the substantially planar composite comprising:
an upper outer surface component comprising a biodegradable and/or compostable polymeric material having a softening point; and
a lower outer surface component comprising a biodegradable and/or compostable polymeric material having a softening point at least around 15° C. lower than the softening point of the biodegradable and/or compostable polymeric material of the upper outer surface component.

19. The form fill seal packaging material according to claim 18, wherein the softening point of the biodegradable and/or compostable polymeric material of the upper outer surface component is around 120 to 170° C.

20. The form fill seal packaging material according to claim 18, wherein the softening point of the biodegradable and/or compostable polymeric material of the lower outer surface component is around 105 to 155° C.

21. The form fill seal packaging material according to claim 18, wherein the softening point of the biodegradable and/or compostable polymeric material of the lower outer surface component is at least around 55° C. lower, in comparison to the softening point of the biodegradable and/or compostable polymeric material of the upper outer surface component.

22. The form fill seal packaging material according to claim 18, wherein the softening point of the biodegradable and/or compostable polymeric material of the lower outer surface component is around 55 to 65° C. lower, in comparison to the softening point of the biodegradable and/or compostable polymeric material of the upper outer surface component.

23. The form fill seal packaging material according to claim 18, wherein:
(a) the softening point of the biodegradable and/or compostable polymeric material of the upper outer surface component is around 80 to 105° C.; and
(b) the softening point of the biodegradable and/or compostable polymeric material of the lower outer surface component is around 55 to 75° C.

24. The form fill seal packaging material according to claim 18, wherein the biodegradable and/or compostable polymeric material of the upper outer surface component comprises a polyester or copolyester comprising monomers of the formula: 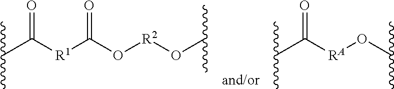
wherein R¹, R² and R^{A} are each independently an optionally substituted C₁₋₉ alkylene, C₆₋₁₀ arylene or 5- or 6-membered heteroarylene group.

25. The form fill seal packaging material according to claim 24, wherein the polyester or copolyester is poly(butylene succinate) (PBS), poly(glycolic acid) (PGA) or a poly(hydroxyalkanoate) (PHA).

26. The form fill seal packaging material according to claim 18, wherein the biodegradable and/or compostable polymeric material of the lower outer surface component comprises a polyester comprising monomers of the formula: 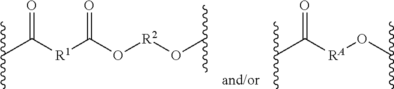
wherein R¹, R² and R^{A} are each independently an optionally substituted C₁₋₉ alkylene, C₆₋₁₀ arylene or 5- or 6-membered heteroarylene group.

27. The form fill seal packaging material according to claim 26, wherein the biodegradable and/or compostable polymeric material of the lower outer surface component is PBAT, poly(caprolactone) (PCL) or poly(lactic acid) (PLA).

28. The form fill seal packaging material according to claim 18, wherein the biodegradable and/or compostable polymeric material of the lower outer surface component is poly(caprolactone) (PCL) or poly(lactic acid) (PLA).

29. The form fill seal packaging material according to claim 23, wherein the biodegradable and/or compostable polymeric material of the lower outer surface component comprises PCL, PLA, PBSA, PBAT, PBST, 2,5-PBAF, 2,5-PBAP, 2,4-PBAP, PBSeT and/or starch.

30. The form fill seal packaging material according to claim 23, wherein the biodegradable and/or compostable polymeric material of the upper outer surface component comprises PBS, PHBV, PHBH, PVOH, PBAT and/or native starch.

31. The form fill seal packaging material according to claim 23, wherein the biodegradable and/or compostable polymeric material of the lower outer surface component comprises PCL, PLA, PBSA and/or PBAT.

32. The form fill seal packaging material according to claim 23, wherein the biodegradable and/or compostable polymeric material of the lower outer surface component comprises PBSA.

33. The form fill seal packaging material according to claim 18 wherein:
(a) the biodegradable and/or compostable polymeric material of the upper outer surface component comprises PHBH and PBAT; and
(b) the biodegradable and/or compostable polymeric material of the lower outer surface component is PBSA; and
(c) the softening point of the biodegradable and/or compostable polymeric material of the upper outer surface component is around 75 to 90° C.; and
(d) the softening point of the biodegradable and/or compostable polymeric material of the lower outer surface component is around 45 to 60° C.

34. The form fill seal packaging material according to claim 18, wherein:
(a) the biodegradable and/or compostable polymeric material of the upper outer surface component comprises PHBH and PBAT; and
(b) the biodegradable and/or compostable polymeric material of the lower outer surface component is PBSA; and
(c) the softening point of the biodegradable and/or compostable polymeric material of the upper outer surface component is around 95 to 110° C.; and
(d) the softening point of the biodegradable and/or compostable polymeric material of the lower outer surface component is around 60 to 85° C.

35. The form fill seal packaging material according to claim 18, wherein the substantially planar composite has a tensile modulus of 50 MPa to 3500 MPa.

36. The form fill seal packaging material according to claim 18, wherein the substantially planar composite does not comprise poly(lactic acid) (PLA).

37. A method of forming a form fill seal packaging material according to claim 18, wherein the method comprises:
extruding the biodegradable and/or compostable polymeric material of the upper outer surface component to form the upper outer surface component;
extruding the biodegradable and/or compostable polymeric material of the lower outer surface component to form the lower outer surface component; and
connecting the upper and lower outer surface components to form the substantially planar composite.
